(19) United States
(12) Patent Application Publication
(10) Pub. No.: US 2026/0323390 A1
(43) Pub. Date: Oct. 15, 2026

(54) TRIGGERING VOICE FRAME AGGREGATION

(71) Applicant: QUALCOMM INCORPORATED, San Diego, CA (US)

(72) Inventors: Toru Uchino, Zushi-shi (JP); Bharat Shrestha, San Diego, CA (US); Xiao Feng Wang, San Diego, CA (US); Alberto Rico Alvarino, San Diego, CA (US); Haris Zisimopoulos, London (GB); Masato Kitazoe, Hachioji-shi (JP); Umesh Phuyal, San Diego, CA (US); Ozcan Ozturk, San Diego, CA (US); Nikolai Konrad Leung, San Francisco, CA (US)

(21) Appl. No.: 18/880,813

(22) PCT Filed: Aug. 8, 2023
(86) PCT No.: PCT/US2023/029696

§ 371 Date: Jan. 2, 2025

(30) Foreign Application Priority Data
Aug. 8, 2022 (GR) 20220100663

(51) Int. Cl. H04W 28/06; H04L 65/1069; H04L 65/70; H04L 65/80; H04W 28/02

(52) U.S. Cl. CPC H04W 28/065; H04L 65/1069; H04L 65/70; H04L 65/80; H04W 28/0268

(57) ABSTRACT

Methods, systems, and devices for wireless communications are described. Some wireless communications systems may support triggering of voice frame aggregation. For example, a user equipment (UE) may generate, via one or more higher layers at the UE, a frame aggregation request message or a session setup message to request activation of frame aggregation. In some cases, the UE may receive, from a network entity via an access stratum layer, an indication of one or more parameters associated with a first frame aggregation configuration. Additionally, the one or more parameters associated with the first frame aggregation configuration may be forwarded to the one or more higher layers at the UE. Further, the UE may transmit one or more data packets in accordance with the first frame aggregation configuration upon successful activation of the frame aggregation.

### CROSS REFERENCE

The present Application is a 371 national stage filing of International PCT Application No. PCT/US2023/029696 by Uchino et al. entitled “TRIGGERING VOICE FRAME AGGREGATION,” filed Aug. 8, 2023; and claims priority to Greece Patent Application No. 20220100663 by Uchino et al. entitled “TRIGGERING VOICE FRAME AGGREGATION,” filed Aug. 8, 2022, each of which is assigned to the assignee hereof, and each of which is expressly incorporated by reference in its entirety herein.

### FIELD OF TECHNOLOGY

The following relates to wireless communications, including triggering voice frame aggregation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support triggering voice frame aggregation. Generally, the techniques described herein may enable a user equipment (UE) to trigger voice frame aggregation and receive, via an access stratum (AS) layer at the UE, an indication of a frame aggregation configuration. For example, a UE may generate, via one or more higher layers at the UE (e.g., higher than an AS layer at the UE) a frame aggregation request message or a session setup message to request activation of frame aggregation. Additionally, the UE may receive, from a network entity via the AS layer, an indication of one or more parameters associated with a frame aggregation configuration, where the one or more parameters includes at least a first parameter indicating a quantity of frames per data packet.

In some cases, the UE may receive the indication of one or more parameters associated with the frame aggregation configuration prior to initiating a session setup procedure with the network entity. That is, the UE may transmit the session setup message, may receive the indication of one or more parameters associated with the frame aggregation configuration based on the session setup message, and may initiate a session setup procedure based on receiving the indication. In some other cases, the UE may receive the indication of one or more parameters associated with the frame aggregation configuration after initiating the session setup procedure with the network entity. That is, the UE may initiate the session setup procedure with the network, transmit the frame aggregation request message based on initiating the session setup procedure, and may receive the indication of one or more parameters associated with the frame aggregation configuration based on the frame aggregation request message.

In some cases, the UE may forward the one or more parameters associated with the first frame aggregation configuration to the one or more higher layers at the UE. Additionally, the UE may transmit, to the network entity, one or more data packets in accordance with the first frame aggregation configuration upon successful activation of the frame aggregation, where each of the one or more data packets includes a set of frames based on the first parameter.

A method for wireless communications at a UE is described. The method may include generating, via one or more higher layers at the UE, a frame aggregation request message or a session setup message to request activation of frame aggregation, receiving, from a network entity via an AS layer, an indication of one or more parameters associated with a first frame aggregation configuration, where the one or more parameters includes at least a first parameter indicating a first quantity of frames per data packet, and where the one or more parameters associated with the first frame aggregation configuration are forwarded to the one or more higher layers at the UE, and transmitting, to the network entity, one or more data packets in accordance with the first frame aggregation configuration upon successful activation of frame aggregation, where each of the one or more data packets includes a set of multiple frames based on the first parameter.

An apparatus for wireless communications at a UE is described. The apparatus may include a processor, memory coupled with the processor, and instructions stored in the memory. The instructions may be executable by the processor to cause the apparatus to generate, via one or more higher layers at the UE, a frame aggregation request message or a session setup message to request activation of frame aggregation, receive, from a network entity via an AS layer, an indication of one or more parameters associated with a first frame aggregation configuration, where the one or more parameters includes at least a first parameter indicating a first quantity of frames per data packet, and where the one or more parameters associated with the first frame aggregation configuration are forwarded to the one or more higher layers at the UE, and transmit, to the network entity, one or more data packets in accordance with the first frame aggregation configuration upon successful activation of frame aggregation, where each of the one or more data packets includes a set of multiple frames based on the first parameter.

Another apparatus for wireless communications at a UE is described. The apparatus may include means for generating, via one or more higher layers at the UE, a frame aggregation request message or a session setup message to request activation of frame aggregation, means for receiving, from a network entity via an AS layer, an indication of one or more parameters associated with a first frame aggregation configuration, where the one or more parameters includes at least a first parameter indicating a first quantity of frames per data packet, and where the one or more parameters associated with the first frame aggregation configuration are forwarded to the one or more higher layers at the UE, and means for transmitting, to the network entity, one or more data packets in accordance with the first frame aggregation configuration upon successful activation of frame aggregation, where each of the one or more data packets includes a set of multiple frames based on the first parameter.

A non-transitory computer-readable medium storing code for wireless communications at a UE is described. The code may include instructions executable by a processor to generate, via one or more higher layers at the UE, a frame aggregation request message or a session setup message to request activation of frame aggregation, receive, from a network entity via an AS layer, an indication of one or more parameters associated with a first frame aggregation configuration, where the one or more parameters includes at least a first parameter indicating a first quantity of frames per data packet, and where the one or more parameters associated with the first frame aggregation configuration are forwarded to the one or more higher layers at the UE, and transmit, to the network entity, one or more data packets in accordance with the first frame aggregation configuration upon successful activation of frame aggregation, where each of the one or more data packets includes a set of multiple frames based on the first parameter.

Some examples of the method, apparatuses, and non-transitory computer-readable medium described herein may further include operations, features, means, or instructions for transmitting the session setup message, where receiving the indication of the one or more parameters associated with the first frame aggregation configuration may be based on transmitting the session setup message, initiating a session setup procedure with the network entity based on receiving the indication of the one or more parameters associated with the first frame aggregation configuration, and transmitting an indication of one or more timing parameters associated with a session, where the one or more timing parameters may be based on the first frame aggregation configuration.

Some examples of the method, apparatuses, and non-transitory computer-readable medium described herein may further include operations, features, means, or instructions for initiating a session setup procedure with the network entity and transmitting the frame aggregation request message, where receiving the indication of the one or more parameters associated with the first frame aggregation configuration may be based on the frame aggregation request message.

In some examples of the method, apparatuses, and non-transitory computer-readable medium described herein, receiving the indication of the one or more parameters associated with the first frame aggregation configuration may include operations, features, means, or instructions for receiving an indication of one or more quality of service parameters associated with a communication link between the UE and the network entity, where the one or more parameters associated with the first frame aggregation configuration may be based on the one or more quality of services parameters.

In some examples of the method, apparatuses, and non-transitory computer-readable medium described herein, the one or more quality of service parameters include the first parameter indicating the first quantity of frames per data packet.

In some examples of the method, apparatuses, and non-transitory computer-readable medium described herein, receiving the indication of one or more quality of service parameters may include operations, features, means, or instructions for receiving an indication of a second parameter from the one or more quality of service parameters and determining the first parameter indicating the first quantity of frames per data packet based on the second parameter from the one or more quality of service parameters.

In some examples of the method, apparatuses, and non-transitory computer-readable medium described herein, transmitting the one or more data packets may include operations, features, means, or instructions for transmitting the one or more data packets in accordance with the first parameter based on a protocol associated with the first radio network, one or more characteristics associated with the first radio network, or both.

Some examples of the method, apparatuses, and non-transitory computer-readable medium described herein may further include operations, features, means, or instructions for transmitting a report indicating one or more parameters associated with a frame aggregation configuration used in a last connection between the UE and a second network entity, where the one or more parameters associated with the first frame aggregation configuration may be based on the one or more parameters associated with the frame aggregation configuration used in a last connection.

Some examples of the method, apparatuses, and non-transitory computer-readable medium described herein may further include operations, features, means, or instructions for receiving, via the AS layer, a second indication of one or more parameters associated with a second frame aggregation configuration, where the one or more parameters associated with the second frame aggregation configuration includes at least a second parameter indication a second quantity of frames per data packet, where the second quantity of frames may be different than the first quantity of frames.

Some examples of the method, apparatuses, and non-transitory computer-readable medium described herein may further include operations, features, means, or instructions for refraining from transmitting a first data packet of the one or more data packets based on the second indication, where the first data packet includes the first quantity of frames.

Some examples of the method, apparatuses, and non-transitory computer-readable medium described herein may further include operations, features, means, or instructions for reconstructing a first data packet of the one or more data packets into a second data packet of the one or more data packets, where the first data packet includes the first quantity of frames and the second data packet includes the second quantity of frames.

Some examples of the method, apparatuses, and non-transitory computer-readable medium described herein may further include operations, features, means, or instructions for transmitting an indication of a quantity of data packets based on receiving the second indication, where the quantity of data packets may be based on a quantity of data packets from the one or more data packets each including the first quantity of data frames.

Some examples of the method, apparatuses, and non-transitory computer-readable medium described herein may further include operations, features, means, or instructions for receiving an indication of one or more recommended timing parameters associated with a communication session between the UE and the network entity, where the one or more recommended timing parameters may be based on the one or more parameters associated with the first frame aggregation configuration.

Some examples of the method, apparatuses, and non-transitory computer-readable medium described herein may further include operations, features, means, or instructions for transmitting a confirmation message indicating the successful activation of the frame aggregation.

In some examples of the method, apparatuses, and non-transitory computer-readable medium described herein, transmitting the one or more data packets may include operations, features, means, or instructions for transmitting the one or more data packets via a communication channel of a set of multiple communication channels, where the communication channel may be based on the first frame aggregation configuration.

A method for wireless communications at a network entity is described. The method may include transmitting an indication of one or more parameters associated with a first frame aggregation configuration based on receiving a frame aggregation request message or a session setup message, where the one or more parameters includes at least a first parameter indicating a first quantity of frames per data packet and receiving one or more data packets in accordance with the first frame aggregation configuration upon successful activation of frame aggregation, where each of the one or more data packets includes a set of multiple frames based on the first parameter.

An apparatus for wireless communications at a network entity is described. The apparatus may include a processor, memory coupled with the processor, and instructions stored in the memory. The instructions may be executable by the processor to cause the apparatus to transmit an indication of one or more parameters associated with a first frame aggregation configuration based on receiving a frame aggregation request message or a session setup message, where the one or more parameters includes at least a first parameter indicating a first quantity of frames per data packet and receive one or more data packets in accordance with the first frame aggregation configuration upon successful activation of frame aggregation, where each of the one or more data packets includes a set of multiple frames based on the first parameter.

Another apparatus for wireless communications at a network entity is described. The apparatus may include means for transmitting an indication of one or more parameters associated with a first frame aggregation configuration based on receiving a frame aggregation request message or a session setup message, where the one or more parameters includes at least a first parameter indicating a first quantity of frames per data packet and means for receiving one or more data packets in accordance with the first frame aggregation configuration upon successful activation of frame aggregation, where each of the one or more data packets includes a set of multiple frames based on the first parameter.

A non-transitory computer-readable medium storing code for wireless communications at a network entity is described. The code may include instructions executable by a processor to transmit an indication of one or more parameters associated with a first frame aggregation configuration based on receiving a frame aggregation request message or a session setup message, where the one or more parameters includes at least a first parameter indicating a first quantity of frames per data packet and receive one or more data packets in accordance with the first frame aggregation configuration upon successful activation of frame aggregation, where each of the one or more data packets includes a set of multiple frames based on the first parameter.

Some examples of the method, apparatuses, and non-transitory computer-readable medium described herein may further include operations, features, means, or instructions for receiving the session setup message, where transmitting the indication of the one or more parameters associated with the first frame aggregation configuration may be based on receiving the session setup message, initiating a session setup procedure with a UE based on transmitting the indication of the one or more parameters associated with the first frame aggregation configuration, and receiving an indication of one or more timing parameters associated with a session, where the one or more timing parameters may be based on the first frame aggregation configuration.

Some examples of the method, apparatuses, and non-transitory computer-readable medium described herein may further include operations, features, means, or instructions for initiating a session setup procedure with a UE and receiving the frame aggregation request message, where receiving the indication of the one or more parameters associated with the first frame aggregation configuration may be based on the frame aggregation request message.

In some examples of the method, apparatuses, and non-transitory computer-readable medium described herein, transmitting the indication of the one or more parameters associated with the first frame aggregation configuration may include operations, features, means, or instructions for transmitting an indication of one or more quality of service parameters associated with a communication link between a UE and the network entity, where the one or more parameters associated with the first frame aggregation configuration may be based on the one or more quality of services parameters.

In some examples of the method, apparatuses, and non-transitory computer-readable medium described herein, the one or more quality of service parameters include the first parameter indicating the first quantity of frames per data packet.

In some examples of the method, apparatuses, and non-transitory computer-readable medium described herein, transmitting the indication of the one or more parameters associated with the first frame aggregation configuration may include operations, features, means, or instructions for transmitting an indication of a second parameter from the one or more quality of service parameters, where the first quantity of frames per data packet may be based on the second parameter from the one or more quality of service parameters.

In some examples of the method, apparatuses, and non-transitory computer-readable medium described herein, receiving the one or more data packets may include operations, features, means, or instructions for receiving the one or more data packets in accordance with the first parameter based on a protocol associated with the first radio network, one or more characteristics associated with the first radio network, or both.

Some examples of the method, apparatuses, and non-transitory computer-readable medium described herein may further include operations, features, means, or instructions for receiving a report indicating one or more parameters associated with a frame aggregation configuration used in a last connection between a UE and a second network entity, where the one or more parameters associated with the first frame aggregation configuration may be based on the one or more parameters associated with the frame aggregation configuration used in a last connection.

Some examples of the method, apparatuses, and non-transitory computer-readable medium described herein may further include operations, features, means, or instructions for transmitting a second indication of one or more parameters associated with a second frame aggregation configuration, where the one or more parameters associated with the second frame aggregation configuration includes at least a second parameter indication a second quantity of frames per data packet, and where the second quantity of frames may be different than the first quantity of frames.

Some examples of the method, apparatuses, and non-transitory computer-readable medium described herein may further include operations, features, means, or instructions for refraining from monitoring for a first data packet of the one or more data packets based on the second indication, where the first data packet includes the first quantity of frames.

Some examples of the method, apparatuses, and non-transitory computer-readable medium described herein may further include operations, features, means, or instructions for receiving an indication of a quantity of data packets based on receiving the second indication, where the quantity of data packets may be based on a quantity of data packets from the one or more data packets each including the first quantity of data frames.

Some examples of the method, apparatuses, and non-transitory computer-readable medium described herein may further include operations, features, means, or instructions for transmitting an indication of one or more recommended timing parameters associated with a communication session between a UE and the network entity, where the one or more recommended timing parameters may be based on the one or more parameters associated with the first frame aggregation configuration.

Some examples of the method, apparatuses, and non-transitory computer-readable medium described herein may further include operations, features, means, or instructions for receiving a confirmation message indicating enablement of the first frame aggregation configuration.

In some examples of the method, apparatuses, and non-transitory computer-readable medium described herein, receiving the one or more data packets may include operations, features, means, or instructions for receiving the one or more data packets via a communication channel of a set of multiple communication channels, where the communication channel may be based on the first frame aggregation configuration.

### BRIEF DESCRIPTION OF THE DRAWINGS

FIG. 1 illustrates an example of a wireless communications system that supports triggering voice frame aggregation in accordance with one or more aspects of the present disclosure.

FIG. 2 illustrates an example of a wireless communications system that supports triggering voice frame aggregation in accordance with one or more aspects of the present disclosure.

FIG. 3 illustrates an example of a process flow that supports triggering voice frame aggregation in accordance with one or more aspects of the present disclosure.

FIGS. 4 and 5 show block diagrams of devices that support triggering voice frame aggregation in accordance with one or more aspects of the present disclosure.

FIG. 6 shows a block diagram of a communications manager that supports triggering voice frame aggregation in accordance with one or more aspects of the present disclosure.

FIG. 7 shows a diagram of a system including a device that supports triggering voice frame aggregation in accordance with one or more aspects of the present disclosure.

FIGS. 8 and 9 show block diagrams of devices that support triggering voice frame aggregation in accordance with one or more aspects of the present disclosure.

FIG. 10 shows a block diagram of a communications manager that supports triggering voice frame aggregation in accordance with one or more aspects of the present disclosure.

FIG. 11 shows a diagram of a system including a device that supports triggering voice frame aggregation in accordance with one or more aspects of the present disclosure.

FIGS. 12 through 15 show flowcharts illustrating methods that support triggering voice frame aggregation in accordance with one or more aspects of the present disclosure.

### DETAILED DESCRIPTION

Some wireless communications systems may support frame aggregation to reduce protocol overhead. For example, a user equipment (UE) may aggregate two or more Internet Protocol (IP) packets into a single transport block (TB). Similarly, the UE may aggregate two or more frames, such as voice frames, intro a single data packet at a Real-Time Transport Protocol (RTP) layer, such may be referred to as an RTP packet. For example, during a session setup, the UE may transmit one or more timing parameters associated with the session to support frame aggregation. In another example, during connection establishment, the UE may transmit a frame aggregation update message to update a quantity of frames per packet to support frame aggregation. However, conventional techniques may not support the UE activating, or triggering, frame aggregation. Additionally, or alternatively, a network entity may not be aware of activation of the frame aggregation, which may result in an increase in latency, failed transmissions, communication inefficiencies, or the like thereof.

Accordingly, techniques described herein may support triggering of frame aggregation. In some cases, a UE may trigger voice frame aggregation prior to initiating a session setup procedure. For example, the UE may generate, via one or more higher layers (e.g., upper layers) at the UE, a session setup message and may transmit, to a network entity, the session setup message to request activation of frame aggregation. In such case, the UE may receive, from the network entity via an access stratum (AS) layer at the UE, an indication of one or more parameters associated with a frame aggregation configuration based on transmitting the session setup message, where the one or more parameters includes at least a first parameter indicating a quantity of frames for the UE to aggregate per data packet. Additionally, the UE may initiate the session setup procedure based on receiving the indication. Alternatively, the UE may trigger voice frame aggregation after initiating the session setup procedure. For example, the UE may initiate the session setup procedure with the network entity and may transmit a frame aggregation request message (e.g., generated via the one or more higher layers) to request activation of the frame aggregation. In such cases, the UE may receive, from the network entity via the AS layer at the UE, the indication of one or more parameters associated with the frame aggregation configuration based on the frame aggregation request message.

Additionally, the UE may forward the one or more parameters associated with the frame aggregation configuration to one or more higher layers (e.g., upper layers) at the UE and may transmit, to the network entity, one or more data packets in accordance with the first frame aggregation configuration upon successful activation of the frame aggregation. That is, each of the one or more data packets may include a quantity of aggregated frames based on the first parameter.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to triggering voice frame aggregation.

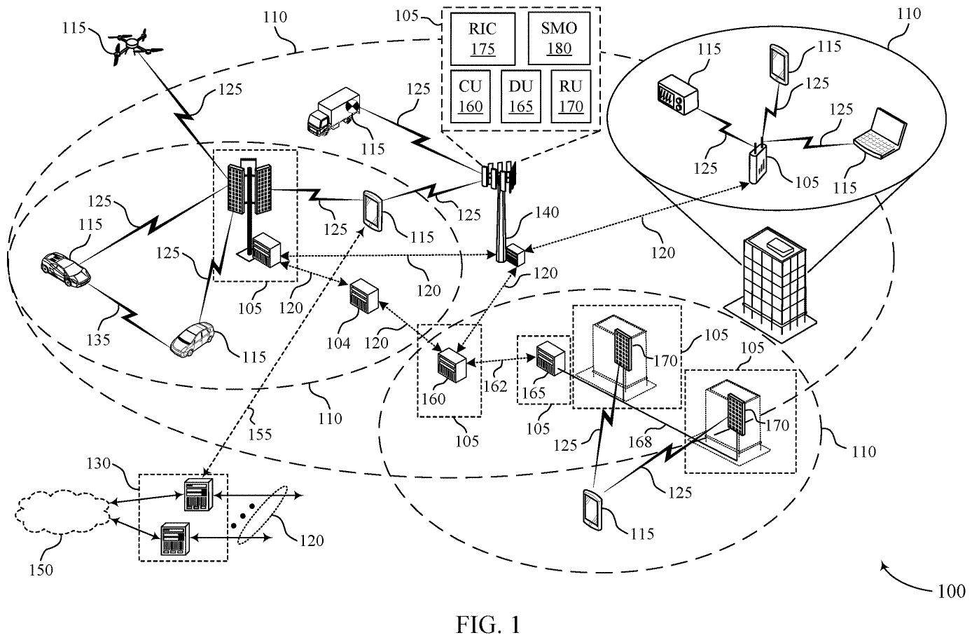

FIG. 1 illustrates an example of a wireless communications system 100 that supports triggering voice frame aggregation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support triggering voice frame aggregation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Nf may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, IP connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support triggering of frame aggregation. In some cases, a UE 115 may trigger voice frame aggregation prior to initiating a session setup procedure. For example, the UE 115 may generate, via one or more higher layers (e.g., upper layers) at the UE 115, a session setup message and may transmit, to a network entity 105, the session setup message to request activation of frame aggregation. In such case, the UE 115 may receive, from the network entity via an AS layer at the UE 115, an indication of one or more parameters associated with a frame aggregation configuration based on transmitting the session setup message, where the one or more parameters includes at least a first parameter indicating a quantity of frames for the UE 115 to aggregate per data packet. Additionally, the UE 115 may initiate the session setup procedure with the network entity 105 based on receiving the indication. Alternatively, the UE 115 may trigger voice frame aggregation after initiating the session setup procedure. For example, the UE 115 may initiate the session setup procedure with the network entity 105 and may transmit a frame aggregation request message (e.g., generated via the one or more higher layers) to request activation of the frame aggregation. In such cases, the UE 115 may receive, from the network entity 105 via the AS layer at the UE 115, the indication of one or more parameters associated with the frame aggregation configuration based on the frame aggregation request message.

Additionally, the UE 115 may forward the one or more parameters associated with the frame aggregation configuration to one or more higher layers (e.g., upper layers) at the UE 115. In some cases, the UE 115 may transmit, to the network entity 105, a confirmation message indicating successful activation of the frame aggregation. Additionally, the UE 115 may transmit, to the network entity 105, one or more data packets in accordance with the first frame aggregation configuration upon the successful activation of the frame aggregation. That is, each of the one or more data packets may include a quantity of aggregated frames based on the first parameter.

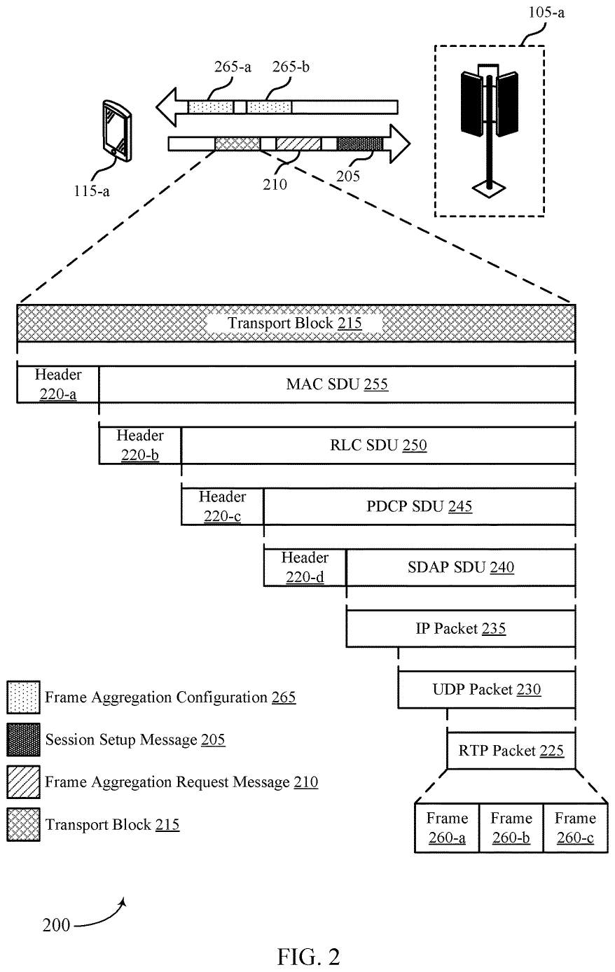

FIG. 2 illustrates an example of a wireless communications system 200 that supports triggering voice frame aggregation in accordance with one or more aspects of the present disclosure. In some examples, the wireless communications system 200 may implement or be implemented by aspects of the wireless communications system 100. For example, the wireless communications system 200 may include one or more network entities 105 (e.g., a network entity 105-a) and one or more UEs 115 (e.g., a UE 115-a), which may be examples of the corresponding devices described herein with reference to FIG. 1. In the example of FIG. 2, the network entity 105-a may be examples of a CU 160, a DU 165, an RU 170, a base station 140, an IAB node 104, or one or more other network nodes as described herein with reference to FIG. 1. In some cases, the UE 115-a may support generation of a session setup message 205 or a frame aggregation request message 210 to request activation of frame aggregation at the UE 115-a.

Some wireless communications systems, such as the wireless communications system 200, may support transmission of transport blocks 215, where the transport block 215 includes multiple packets (e.g., generated by a codec per 20 ms). In some cases, each packet may be associated with a header 220, which may increase overhead (e.g., and reduce data rates achievable in non-terrestrial networks (NTNs)). For example, the transport block 215 may include an RTP packet 225, a user datagram protocol (UDP) packet 230, an IP packet 235, an SDAP service data unit (SDU) 245, a PDCP SDU 245, an RLC SDU 250, and a MAC SDU 255, each associated with a header 220. For example, (e.g., at an initial state of robust header compression (ROHC) prior to header compression), a transport block 215 may include an RTP header (e.g., 12 bytes, not shown), a UDP header (e.g., 8 bytes, not shown), an IP header (e.g., greater than 20 bytes, not shown), an SDAP header (e.g., 1 byte), which may be referred to as a header 220-d, a PDCP header (e.g., 12 bit secondary node (SN), 2 bytes), which may be referred to as a header 220-c, an RLC header (e.g., 6 bit SN, segmented SDU, 3 bytes), which may be referred to as a header 220-b, and a MAC header (e.g., 8 bit L-field, greater than or equal to 2 bytes), which may be referred to as a header 220-a. As such, the transport block 215 may have higher overhead (e.g., greater than 47 bytes).

In some cases, to reduce overhead (e.g., protocol overhead), a UE 115, such as the UE 115-a, may aggregate two or more IP packets 235 into the transport block 215. For example, an SDAP SDU 240 may include two or more IP packets 235 (not shown). Additionally, or alternatively, the UE 115-a may aggregate two or more frames 260 (e.g., voice frames 260) in an RTP packet 225 (e.g., at an RTP layer), which may be referred to as frame aggregation (e.g., voice frame aggregation or packetization). For example, the RTP packet 225 may include a frame 260-a, a frame 260-b, and a frame 260-c. In some cases, during a session setup procedure, the UE 115-a (e.g., a client UE 115), may transmit, to a network entity 105-a (e.g., in an SDP offer), an indication of one or more timing parameters (e.g., ptime and maxptime) associated with a session between the UE 115-a and the network entity 105-a, where the one or more parameters may support frame aggregation. In some other cases, during connection establishment, the UE 115-a may transmit a frame aggregation update message (e.g., RTCP APP REQ_AGC message) indicating a request to update a quantity (e.g., number) of frames 260 per RTP packet 225 (e.g., data packet) for frame aggregation. However, conventional techniques may not support triggering of frame aggregation by the UE 115-a (e.g., for NTN when coverage enhancements are needed) and may not support frame aggregation in all scenarios (e.g., will not guarantee the frame aggregation will be activated or used). Additionally, one or mor components of the network entity 105-a may be unaware of frame aggregation activation by the UE 115-a (e.g., thus unable to meet guaranteed bit rate (GBR) requirements and scheduling requirements). Additionally, or alternatively, the network entity 105-a may be unable to request a multimedia gateway (MGW) to transmit (e.g., offer) session description protocol (SDP) requesting frame aggregation (e.g., if the UE 115-a has transmitted SDP requesting).

Accordingly, techniques described herein may support frame aggregation (e.g., application layer voice frame aggregation controlled by the network entity 105-b at a RAN or a core network (CN)). In some cases, the UE 115-a may receive, via an AS layer at the UE 115-a, a frame aggregation configuration 265 indicating one or more parameters associated with frame aggregation at the UE 115-a. For example, the UE 115-a may receive, from the network entity 105-a (e.g., RAN), a frame aggregation configuration 265-a indicating the one or more parameters associated with frame aggregation. In some cases, the network entity 105-b may transmit the frame aggregation configuration 265-a to enhance coverage of the UE 115-a and enhance a corresponding resource availability for a larger transport block size (TBS) (e.g., to meet quality of service (QoS) thresholds for voice data radio bearer (DRB)).

In some cases, the one or more parameters may include at least a first parameter indicating a quantity of frames 260 for the UE 115-a to aggregate per packet (e.g., RTP packet 225). For example, a first value of the first parameter (e.g., 01) may indicate for the UE 115-a to aggregate two frames 260 per RTP packet 225 (not shown), a second value of the first parameter (e.g., 10) may indicate for the UE 115-a to aggregate three frames 260 per RTP packet 225 (as depicted in FIG. 2), and a third value of the first parameter (e.g., 11) may indicate for the UE 115-a to aggregate four frames 260 per RTP packet 225 (not shown). Additionally (e.g., for voice packets), the UE 115-a may forward the frame aggregation configuration 265-a from the AS layer at the UE 115-a to one or more higher (e.g., upper) layers at the UE 115-a (e.g., an application layer at the UE 115-a).

In some cases, the UE 115-a may support a default quantity of frames 260 for the UE 115-a to aggregate per RTP packet 225. For example, the default quantity of frames 260 for the UE 115-a to aggregate per RTP packet 225 may be two frames 260 per RTP packet 225 (e.g., when the UE 115-a us using NTN service and low earth orbit (LEO) or medium earth orbit (MEO) satellites). In some cases, the UE 115-a may be configured with multiple radio networks (e.g., terrestrial network (TN) to NTN dual connectivity) such that the UE 115-a may determine the default quantity of frames 260 for the UE 115-a to aggregate per RTP packet 225 based on which radio network the RTP packet 225 is mapped to. That is, each radio network of the multipole radio networks may be associated with a default quantity of frames 260 for the UE 115-a to aggregate per RTP packet 225. For example, a first radio network (e.g., TN) may be mapped to an RLC channel (e.g., resource block, logical channel (LCH)) such that the UE 115-a may determine the default quantity of frames 260 for the UE 115-a to aggregate per RTP packet 225 based on the first radio network. In some other cases, the UE 115-a may determine the default quantity of frames 260 for the UE 115-a to aggregate per RTP packet 225 based on a second radio network (e.g., NTN). In some other cases, the UE 115-a may determine the default quantity of frames 260 for the UE 115-a to aggregate per RTP packet 225 based one or more radio characteristics associated with each radio network of the multiple radio networks (e.g., if a delay is larger than 10 ms, the UE may determine the default quantity of frames 260 for the UE 115-a to aggregate per RTP packet 225 based on NTN). In some cases, a first default quantity of frames 260 for the UE 115-a to aggregate per RTP packet 225 may be associated with a first connection (e.g., a connection between an NTN UE 115 client and a media gateway (MGW)) and a second default quantity of frames 260 for the UE 115-a to aggregate per RTP packet 225 may be associated with a second connection (e.g., a connection between the MGW and a non-NTN UE 115). Additionally, or alternatively, the default quantity of frames 260 for the UE 115-a to aggregate per RTP packet 225 may be based on a quantity of frames 260 for the UE 115-a to aggregate per RTP packet 225 supported in a last connection. In such cases, the UE 115-a may report the quantity of frames 260 for the UE 115-a to aggregate per RTP packet 225 supported in a last connection.

In some cases, the UE 115-a may receive the frame aggregation configuration 265-a prior to initiation of a session setup procedure (e.g., voice session setup) with the network entity 105-a. That is, the UE 115-a may generate a session setup message 205 (e.g., via the one or more higher layers) and may transmit, to the network entity 105-a, the session setup message 205 to request activation of frame aggregation at the UE 115-a. As such, the network entity 105-a may transmit the frame aggregation configuration 265-a based on receiving the session setup message 205 and may initiate the session setup procedure with the UE 115-a based on transmitting the frame aggregation configuration 265-a. Additionally, the UE 115-a may transmit, to the network entity 105-a, an indication of one or more timing parameters (e.g., ptime and maxptime) associated with the session (e.g., via an SDP offer). For example, the UE 115-a may transmit an indication of a first timing parameter of the one or more timing parameters and a second timing parameter of the one or more timing parameters, where a combination of the first timing parameter and the second timing parameter indicates a quantity of frames 260 per RTP packet 225 (e.g., RTP packet 225). As an illustrative example, the first timing parameter (e.g., ptime) may be equal to 20 and the second timing parameter (e.g., maxptime) may be equal to 40, such that the combination of the first timing parameter and the second timing parameter indicates 2 frames 260 per RTP packet 225 of length 20 ms. In some cases, the UE 115-a may activate (e.g., enable) frame aggregation based on receiving, from the network entity 105-a, a response message (e.g., SDP answer) indicating the one or more timing parameters (e.g., as offered by the UE 115-a).

In some cases (e.g., the UE 115-a is an NTN client UE 115 on a receiving end of a connection), a RAN at the network entity 105-a may communication with a MGW at the network entity 105-a (e.g., Multimedia Telephony Service for IMS (MTSI)) via a CN. That is, the MGW may transmit an SDP offer to the UE 115-a indicating a recommend value of the one or more timing parameters associated with the session (if an additional MTSI client UE 115 is associated with an additional network entity 105, the MGW may send the SDP offer to the client UE 115 associated with an NTN network, such as the UE 115-a). In some cases, the MGW may provide confirmation to a RAN at the network entity 105-a based on activation of the frame aggregation.

Alternatively, the UE 115-a may receive the frame aggregation configuration 265-a after initiation of the session setup procedure with the network entity 105-a (e.g., after the session setup procedure is complete). That is, the UE 115-a may perform the session setup procedure with the network entity 105-a and may a may generate a frame aggregation request message 210 (e.g., RTCP_APP_REQ_AGC message) after (e.g., upon) completion of the session setup procedure. Additionally, the UE 115-a may transmit, to the network entity 105-a, the frame aggregation request message 210 to request activation of frame aggregation at the UE 115-a (e.g., or change of frame aggregation). As such, the network entity 105-a may transmit the frame aggregation configuration 265-a based on receiving the frame aggregation request message 210. In some cases, the network entity 105-a may transmit the frame aggregation configuration 265-a via an RRC message (e.g., dedicated RRC message during a voice bearer setup procedure or via an RRC reconfiguration message). Additionally, or alternatively, the network entity 105-a may transmit the frame aggregation configuration 265-a via a MAC-control element (MAC-CE) command (e.g., new MAC-CE command or recommended bit rate MAC-CE command). For example, the network entity 105-a may transmit the frame aggregation configuration 265-a via an RLC control protocol data unit (PDU) (e.g., or header 220 of an RLC data PDU), a PDCP control PDU (e.g., or header 220 of a PDCP data PDU, or an SDAP control PDU (e.g., or header 220 of an SDAP data PDU). Additionally, or alternatively, the frame aggregation configuration 265-a may include an indication of a session (e.g., RTP session) to which the UE 115-a may apply the frame aggregation configuration 265-a. For example, the frame aggregation configuration 265-a may include an indication of an RTP synchronization source (SSRC) identifier, a UDP port, an IP address (and a combination), a quality of service (QoS) identifier (e.g., 5G QoS identifier (5QI), a PDU session identifier (ID), a radio bearer ID, an RLC bearer ID, a LCH ID), or the like thereof.

Additionally, or alternatively, the one or more parameters associated with the frame aggregation configuration 265-a may include one or more QoS parameters, such as a QoS identifier (e.g., 5QI). That is, the network entity 105-a (e.g., CN or RAN) may indicate a QoS identifier (e.g., based on the characteristics of RAN, a value greater than 1 only to NTN RAN) via the frame aggregation configuration 265-a. In some cases, the network entity 105-a may trigger a QoS modification procedure prior to transmitting the indication of the QoS identifier (e.g., if the network entity 105-a prefers other values than that indicated by the CN). In some cases, the network entity 105-a may adjust a packet delay budget (PDB) value for an indicated QoS identifier (e.g., new QoS identifier) due to additional delay in transmission with frame aggregation as compared to transmissions without frame aggregation.

The UE 115-a may determine the first parameter indicating the quantity of frames 260 for the UE 115-a to aggregate per RTP packet 225 (e.g., RTP packet 225) based on the one or more QoS parameters. In some cases, the network entity 105-a may indicate the quantity of frames 260 for the UE 115-a to aggregate per RTP packet 225 based on a value of a first QoS parameter (e.g., the QoS identifier) of the one or more QoS parameters. For example, the value of the first QoS parameter may correspond to a value of the first parameter indicating the quantity of frames 260 for the UE 115-a to aggregate per RTP packet 225. As an illustrative example, a first value of the first QoS parameter (e.g., associated with a first PDB) may correspond to a first quantity of frames 260 (e.g., an explicit value) for the UE 115-a to aggregate per RTP packet 225 (e.g., based on a correlation table). Additionally, or alternatively, a second value of the first QoS parameter (e.g., associated with a second PDB) may correspond to a second quantity of frames 260 for the UE 115-a to aggregate per RTP packet 225 and a third value of the first QoS parameter (e.g., associated with a third PDB) may correspond to a third quantity of frames 260 for the UE 115-a to aggregate per RTP packet 225.

Additionally, or alternatively, the network entity 105-a may indicate the quantity of frames 260 for the UE 115-a to aggregate per RTP packet 225 based on a characteristic associated with a first QoS parameter of the one or more QoS parameters (e.g., the UE 115-a may derive the quantity of frames 260 implicitly from the value of the first QoS parameter). For example, a first value of the QoS parameter may correspond to a first value of a first characteristic (e.g., maximum data burst volume (MDBV)) associated with the first QoS parameter. Additionally, the first value of the first characteristic associated with the first QoS parameter may correspond to a first packet size (e.g., each MDBV value corresponds to a packet size for multiple frame scenarios). As such, the UE 115-a may determine a first quantity of frames 260 for the UE 115-a to aggregate per RTP packet 225 (e.g., a packet size for multiple frame cases) based on the first packet size. In some cases, the packet size may be an explicit packet size (e.g., an exact packet size) or may be a packet size per quantity of frames 260 (e.g., packet size for 2 bundling, actual packed size may depend on codec rate).

Additionally, the UE 115-a may aggregate one or more data packets based on the frame aggregation configuration 265-a upon successful activation of the frame aggregation. In some cases, the UE 115-a may transmit, to the network entity 105-a, an indication that the activation of the frame aggregation was successful (e.g., the frame aggregation request was successful) to support resource allocation by the network entity 105-a (e.g., to enable the network entity 105-a to allocate resources to the UE 115-a accordingly for avoiding segmentation and enhance coverage). In some cases, the indication may include a frame aggregation size (e.g., the quantity of frames 260 per RTP packet 225). In some cases, the UE 115-a may explicitly indicate that the activation of the frame aggregation was successful via a control message (e.g., RRC message for UE assistance information or a confirmation MAC-CE via uplink). In some other cases, the UE 115-a may implicitly indicate that the activation of the frame aggregation was successful. That is, the network entity 105-a may configure the UE 115-a with a set of communication channels (e.g., radio bearers, RLC channel/bearer, LCH) and the UE 115-a may transmit the one or more data packets (e.g., RTP packets 225) via a first communication channel from the set of communication channels, where the first communication channel is associated (e.g., mapped) with the quantity of frames 260 aggregated by the UE 115-a per RTP packet 225. As such, the network entity 105-a may determine (e.g., identify) the quantity of frames 260 aggregated by the UE 115-a per RTP packet 225 based on the first communication channel (e.g., used to transmit the one or more data packets).

In some cases, the network entity 105-a may transmit a frame aggregation configuration 265-b indicating an updated quantity of frames 260 for the UE 115-a to aggregate per RTP packet 225 (e.g., after the session has been set up). In some cases, the network entity 105-a may transmit the frame aggregation configuration 265-b based on radio environment changes at the UE 115-a, the UE 115-a performing a handover procedure, RRC re-establishment, a data path change (e.g., in carrier aggregation or dual connectivity), or the like thereof. In such cases, a buffer associated with the UE 115-a may contain one or more RTP packets 225, each including the quantity of frames 260 for the UE 115-a to aggregate per RTP packet 225 indicated via the frame aggregation configuration 265-a, which may be referred to as the old quantity of frames 260 in the context of this example. Additionally, the buffer associated with the UE 115-a may contain one or more RTP packets 225 each including the updated quantity of frames 260 for the UE 115-a to aggregate per RTP packet 225, which may result in a reduction in resource efficiency (e.g., due to level 2 overhead, RLC header due to segmentation).

In some cases (e.g., one or more RTP packets 225 each including the old quantity of frames 260 are buffered in an upper layer, such as a second layer), the UE 115-a may discard the one or more RTP packets 225 that each include the old quantity of frames 260 (e.g., triggered by a second layer or an indication from one or more upper layers). In some examples, the UE 115-a may refrain from transmitting the one or more RTP packets 225 that each include the old quantity of frames 260 (e.g., resulting in packet loss). In some other examples, the UE 115-a may reconstruct the one or more RTP packets 225 that each include the old quantity of frames 260 to include the updated quantity of frames 260 (e.g., the UE 115-a may buffer the old packets in the second layer, such as a PDCP layer, and may forward them up to one or more upper layers to be reconstructed to avoid packet loss). In some other cases, the UE 115-a may transmit an indication of a quantity of packets with the old quantity of frames 260 such that the network entity 105-a may transmit (e.g., temporarily provide) an uplink grant corresponding to the old quantity of frames 260.

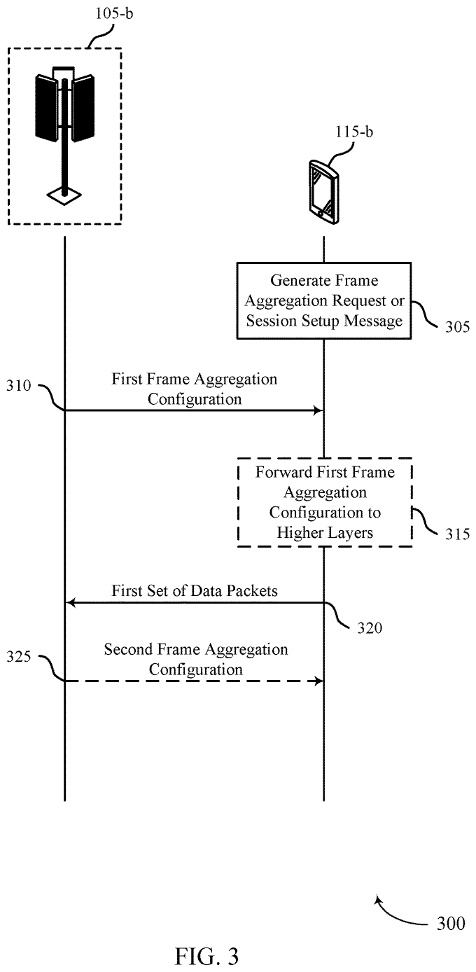

FIG. 3 illustrates an example of a process flow 300 that supports triggering voice frame aggregation in accordance with one or more aspects of the present disclosure. In some examples, the process flow 300 may implement or be implemented by aspects of the wireless communications system 100 and the wireless communications system 200. For example, the process flow 300 may include one or more network entities 105 (e.g., a network entity 105-b) and one or more UEs 115 (e.g., a UE 115-b), which may be examples of the corresponding devices described herein with reference to FIG. 1. In the example of FIG. 3, the network entity 105-b may be examples of a CU 160, a DU 165, an RU 170, a base station 140, an IAB node 104, or one or more other network nodes as described herein with reference to FIG. 1. In some cases, the UE 115-b may support triggering of voice frame aggregation.

In some cases, a network entity 105-b may configure the UE 115-b to trigger frame aggregation (e.g., configuring voice DRB). That is, the UE 115-b may receive, from the network entity 105-b, a request to trigger frame aggregation (e.g., an indication of a frame aggregation request). Additionally, the UE 115-b may indicate, via an AS layer at the UE 115-b, the request to trigger frame aggregation (e.g., indicating a quantity of frames per packet) to one or more higher layers at the UE 115-b.

At 305, the UE 115-b may generate, via the one or more higher layers at the UE 115-b, a frame aggregation request message or a session setup message (e.g., voice session setup message) to request activation of frame aggregation.

In some cases, the UE 115-b may transmit a report indicating one or more parameters associated with a frame aggregation configuration used in a last connection between the UE 115-b and an additional network entity 105.

At 310, the UE 115-b may receive, from the network entity 105-b via an AS layer, an indication of one or more parameters associated with a first frame aggregation configuration, where the one or more parameters includes at least a first parameter indicating a first quantity of frames per data packet. In some cases, the one or more parameters associated with the first frame aggregation configuration may be based on the one or more parameters associated with the frame aggregation configuration used in the last connection.

In some cases, the UE 115-b may receive the indication of one or more parameters associated with the first frame aggregation configuration prior to a session setup procedure. That is, the UE 115-b may transmit the session setup message and may receive the indication of one or more parameters associated with the first frame aggregation configuration based on transmitting the session setup message. Additionally, the UE 115-b may initiate a session setup procedure with the network entity 105-b based on receiving the indication of the one or more parameters associated with the first frame aggregation configuration and may transmit an indication of one or more timing parameters associated with a session, where the one or more timing parameters are based at least in part on the first frame aggregation configuration.

In some cases, the UE 115-b may receive the indication of one or more parameters associated with the first frame aggregation configuration after completion of the session setup procedure. That is, the UE 115-b may initiate the session setup procedure with the network entity 105-b. Additionally, the UE 115-b may transmit the frame aggregation request message and may receive the indication of one or more parameters associated with the first frame aggregation configuration based on the frame aggregation request message.

In some cases, the indication of one or more parameters associated with the first frame aggregation configuration may include an indication of one or more QoS parameters associated with a communication link between the UE 115-b and the network entity 105-b. In some cases, the one or more QoS parameters includes the first parameter indicating the first quantity of frames per data packet. In some other cases, the indication of the one or more QoS parameters may include an indication of a second parameter from the one or more quality of service parameters and the UE 115-b may determine the first parameter indicating the first quantity of frames per data packet based on the second parameter from the one or more QoS parameters

In some cases, the UE 115-b may receive an indication of one or more recommended timing parameters associated with the communication session between the UE 115-b and the network entity 105-b, where the one or more recommended timing parameters are based on the one or more parameters associated with the first frame aggregation configuration.

In some cases, at 315, the UE 115-b may forward the one or more parameters associated with the first frame aggregation configuration to the one or more higher layers at the UE 115-b.

In some cases, the UE 115-b may transmit, via the AS layer at the UE 115-b, a confirmation message (e.g., acknowledgement message) indicating the successful activation of the frame aggregation (e.g., upon the successful activation of frame aggregation).

At 320, the UE 115-b may transmit, via the one or more higher layers at the UE 115-b, one or more data packets in accordance with the first frame aggregation configuration upon successful activation of the frame aggregation, where each of the one or more data packets includes multiple frames based at least in part on the first parameter.

In some cases, the first parameter from the one or more parameters is associated with a first radio network and a second parameter from the one or more parameters is associated with a second radio network. In such cases, the UE 115-b may transmit the one or more data packets in accordance with the first parameter based on a protocol associated with the first radio network, one or more characteristics associated with the first radio network, or both.

In some cases, the UE 115-b may transmit the one or more data packets via a communication channel of a set of communication channels, where the communication channel from the set of communication channels is based at least in part on the first frame aggregation configuration.

In some cases, at 325, the UE 115-b may receive, via the AS layer, a second indication of one or more parameters associated with a second frame aggregation configuration, where the one or more parameters associated with the second frame aggregation configuration includes at least a second parameter indication a second quantity of frames per data packet. In some cases, the second quantity of frames may be different than the first quantity of frames. In some examples, the UE 115-b may refrain from transmitting a first data packet of the one or more data packets based on the second indication, where the first data packet comprises the first quantity of frames. In such cases, the network entity 105-b may refrain from monitoring for the first data packet of the one or more data packets based on the second indication. In some other examples, the UE 115-b may reconstruct the first data packet of the one or more data packets into a second data packet of the one or more data packets, where the second data packet includes the second quantity of frames. Additionally, or alternatively, the UE 115-b may transmit an indication of a quantity of data packets based on receiving the second indication, where the quantity of data packets is based on a quantity of data packets from the one or more data packets each including the first quantity of data frames.

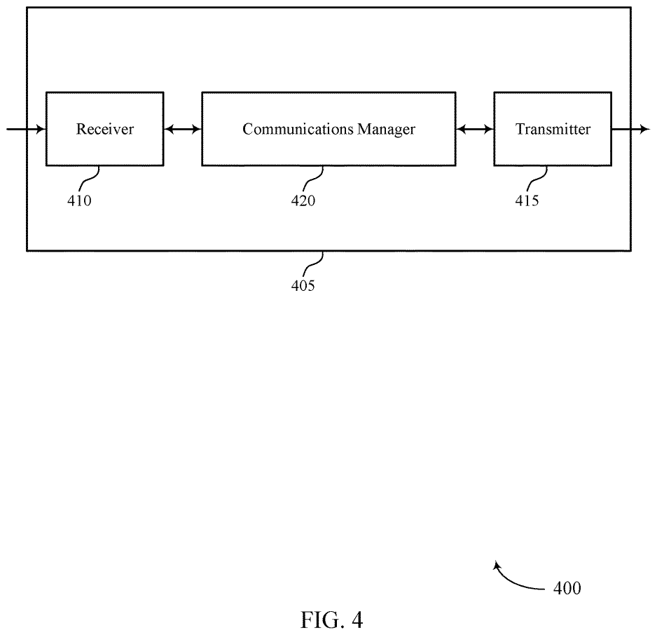

FIG. 4 shows a block diagram 400 of a device 405 that supports triggering voice frame aggregation in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to triggering voice frame aggregation). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to triggering voice frame aggregation). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of triggering voice frame aggregation as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 may be configured as or otherwise support a means for generating, via one or more higher layers at the UE, a frame aggregation request message or a session setup message to request activation of frame aggregation. The communications manager 420 may be configured as or otherwise support a means for receiving, from a network entity via an access stratum layer, an indication of one or more parameters associated with a first frame aggregation configuration, where the one or more parameters includes at least a first parameter indicating a first quantity of frames per data packet, and where the one or more parameters associated with the first frame aggregation configuration are forwarded to the one or more higher layers at the UE. The communications manager 420 may be configured as or otherwise support a means for transmitting, to the network entity, one or more data packets in accordance with the first frame aggregation configuration upon successful activation of the frame aggregation, where each of the one or more data packets includes a plurality of frames based at least in part on the first parameter.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for triggering voice frame aggregation which may result in reduced processing, reduced power consumption, and more efficient utilization of communication resources, among other advantages.

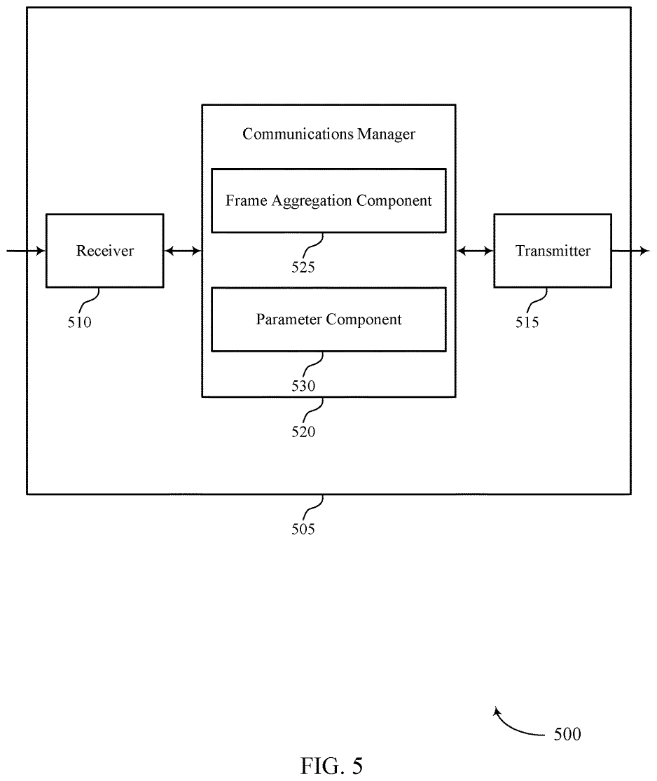

FIG. 5 shows a block diagram 500 of a device 505 that supports triggering voice frame aggregation in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to triggering voice frame aggregation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to triggering voice frame aggregation). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of triggering voice frame aggregation as described herein. For example, the communications manager 520 may include a frame aggregation component 525 a parameter component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The frame aggregation component 525 may be configured as or otherwise support a means for generating, via one or more higher layers at the UE, a frame aggregation request message or a session setup message to request activation of frame aggregation. The parameter component 530 may be configured as or otherwise support a means for receiving, from a network entity via an access stratum layer, an indication of one or more parameters associated with a first frame aggregation configuration, where the one or more parameters includes at least a first parameter indicating a first quantity of frames per data packet, and where the one or more parameters associated with the first frame aggregation configuration are forwarded to the one or more higher layers at the UE. The frame aggregation component 525 may be configured as or otherwise support a means for transmitting, to the network entity, one or more data packets in accordance with the first frame aggregation configuration upon successful activation of the frame aggregation, where each of the one or more data packets includes a plurality of frames based at least in part on the first parameter.

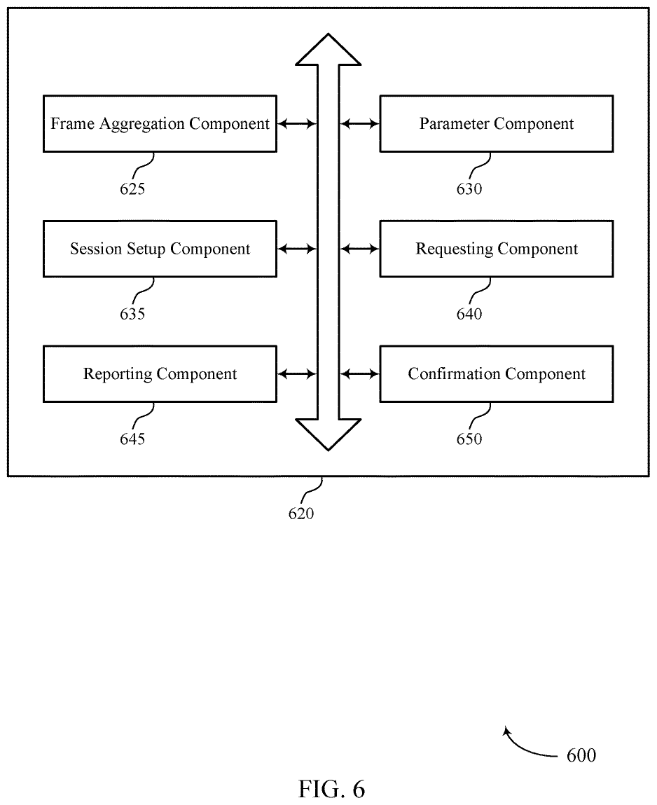

FIG. 6 shows a block diagram 600 of a communications manager 620 that supports triggering voice frame aggregation in accordance with one or more aspects of the present disclosure. The communications manager 620 may be an example of aspects of a communications manager 420, a communications manager 520, or both, as described herein. The communications manager 620, or various components thereof, may be an example of means for performing various aspects of triggering voice frame aggregation as described herein. For example, the communications manager 620 may include a frame aggregation component 625, a parameter component 630, a session setup component 635, a requesting component 640, a reporting component 645, a confirmation component 650, or any combination thereof. Each of these components may communicate, directly or indirectly, with one another (e.g., via one or more buses).

The communications manager 620 may support wireless communications at a UE in accordance with examples as disclosed herein. The frame aggregation component 625 may be configured as or otherwise support a means for generating, via one or more higher layers at the UE, a frame aggregation request message or a session setup message to request activation of frame aggregation. The parameter component 630 may be configured as or otherwise support a means for receiving, from a network entity via an access stratum layer, an indication of one or more parameters associated with a first frame aggregation configuration, where the one or more parameters includes at least a first parameter indicating a first quantity of frames per data packet, and where the one or more parameters associated with the first frame aggregation configuration are forwarded to the one or more higher layers at the UE. In some examples, the frame aggregation component 625 may be configured as or otherwise support a means for transmitting, to the network entity, one or more data packets in accordance with the first frame aggregation configuration upon successful activation of the frame aggregation, where each of the one or more data packets includes a plurality of frames based at least in part on the first parameter.

In some examples, the session setup component 635 may be configured as or otherwise support a means for transmitting the session setup message, where receiving the indication of the one or more parameters associated with the first frame aggregation configuration is based at least in part on transmitting the session setup message. In some examples, the session setup component 635 may be configured as or otherwise support a means for initiating a session setup procedure with the network entity based at least in part on receiving the indication of the one or more parameters associated with the first frame aggregation configuration. In some examples, the parameter component 630 may be configured as or otherwise support a means for transmitting an indication of one or more timing parameters associated with a session, where the one or more timing parameters are based at least in part on the first frame aggregation configuration.

In some examples, the session setup component 635 may be configured as or otherwise support a means for initiating a session setup procedure with the network entity. In some examples, the requesting component 640 may be configured as or otherwise support a means for transmitting the frame aggregation request message, where receiving the indication of the one or more parameters associated with the first frame aggregation configuration is based at least in part on the frame aggregation request message.

In some examples, to support receiving the indication of the one or more parameters associated with the first frame aggregation configuration, the parameter component 630 may be configured as or otherwise support a means for receiving an indication of one or more QoS parameters associated with a communication link between the UE and the network entity, where the one or more parameters associated with the first frame aggregation configuration is based at least in part on the one or more QoS parameters.

In some examples, the one or more QoS parameters include the first parameter indicating the first quantity of frames per data packet.

In some examples, to support receiving the indication of one or more QoS parameters, the parameter component 630 may be configured as or otherwise support a means for receiving an indication of a second parameter from the one or more QoS parameters. In some examples, to support receiving the indication of one or more QoS parameters, the parameter component 630 may be configured as or otherwise support a means for determining the first parameter indicating the first quantity of frames per data packet based at least in part on the second parameter from the one or more QoS parameters.

In some examples, to support transmitting the one or more data packets, the frame aggregation component 625 may be configured as or otherwise support a means for transmitting the one or more data packets in accordance with the first parameter based at least in part on a protocol associated with the first radio network, one or more characteristics associated with the first radio network, or both.

In some examples, the reporting component 645 may be configured as or otherwise support a means for transmitting a report indicating one or more parameters associated with a frame aggregation configuration used in a last connection between the UE and a second network entity, where the one or more parameters associated with the first frame aggregation configuration are based at least in part on the one or more parameters associated with the frame aggregation configuration used in the last connection.

In some examples, the parameter component 630 may be configured as or otherwise support a means for receiving, via the access stratum layer, a second indication of one or more parameters associated with a second frame aggregation configuration, where the one or more parameters associated with the second frame aggregation configuration includes at least a second parameter indication a second quantity of frames per data packet, where the second quantity of frames is different than the first quantity of frames.

In some examples, the frame aggregation component 625 may be configured as or otherwise support a means for refraining from transmitting a first data packet of the one or more data packets based at least in part on the second indication, where the first data packet includes the first quantity of frames.

In some examples, the frame aggregation component 625 may be configured as or otherwise support a means for reconstructing a first data packet of the one or more data packets into a second data packet of the one or more data packets, where the first data packet includes the first quantity of frames and the second data packet includes the second quantity of frames.

In some examples, the frame aggregation component 625 may be configured as or otherwise support a means for transmitting an indication of a quantity of data packets based at least in part on receiving the second indication, where the quantity of data packets is based at least in part on a quantity of data packets from the one or more data packets each including the first quantity of data frames.

In some examples, the parameter component 630 may be configured as or otherwise support a means for receiving an indication of one or more recommended timing parameters associated with a communication session between the UE and the network entity, where the one or more recommended timing parameters are based at least in part on the one or more parameters associated with the first frame aggregation configuration.

In some examples, the confirmation component 650 may be configured as or otherwise support a means for transmitting a confirmation message indicating the successful activation of the frame aggregation.

In some examples, to support transmitting the one or more data packets, the frame aggregation component 625 may be configured as or otherwise support a means for transmitting the one or more data packets via a communication channel of a plurality of communication channels, where the communication channel is based at least in part on the first frame aggregation configuration.

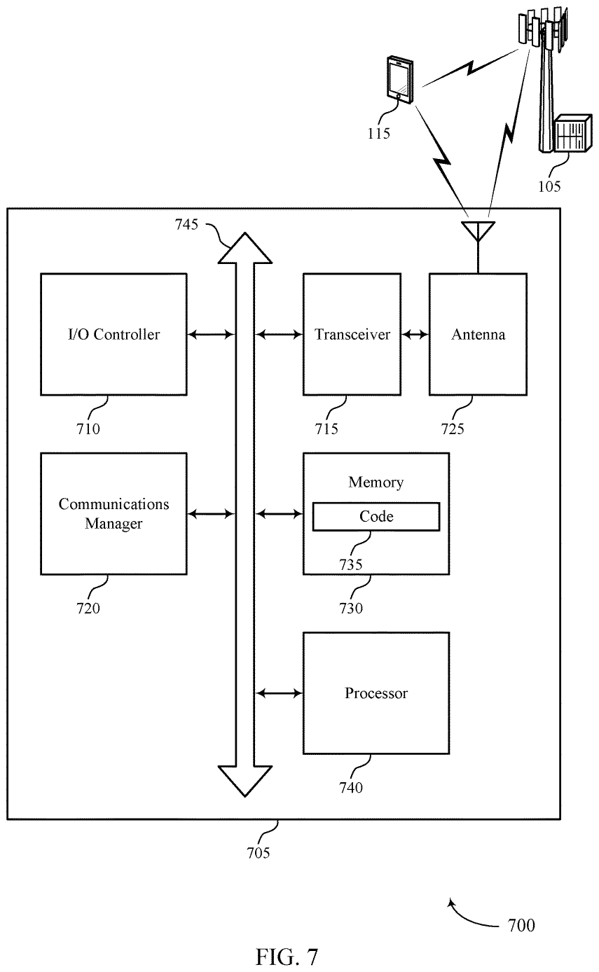

FIG. 7 shows a diagram of a system 700 including a device 705 that supports triggering voice frame aggregation in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting triggering voice frame aggregation). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for generating, via one or more higher layers at the UE, a frame aggregation request message or a session setup message to request activation of frame aggregation. The communications manager 720 may be configured as or otherwise support a means for receiving, from a network entity via an access stratum layer, an indication of one or more parameters associated with a first frame aggregation configuration, where the one or more parameters includes at least a first parameter indicating a first quantity of frames per data packet, and where the one or more parameters associated with the first frame aggregation configuration are forwarded to the one or more higher layers at the UE. The communications manager 720 may be configured as or otherwise support a means for transmitting, to the network entity, one or more data packets in accordance with the first frame aggregation configuration upon successful activation of the frame aggregation, where each of the one or more data packets includes a plurality of frames based at least in part on the first parameter.

By including or configuring the communications manager 720 in accordance with examples as described herein, the device 705 may support techniques for triggering voice frame aggregation which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of triggering voice frame aggregation as described herein, or the processor 740 and the memory 730 may be otherwise configured to perform or support such operations.

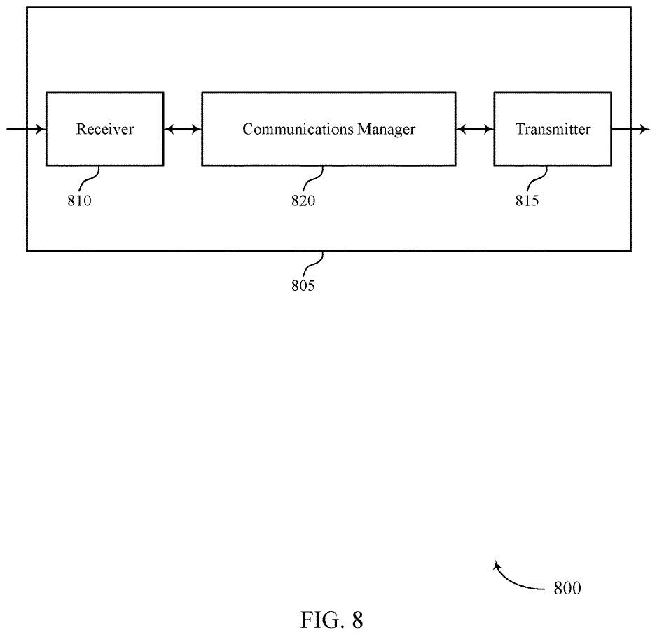

FIG. 8 shows a block diagram 800 of a device 805 that supports triggering voice frame aggregation in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of triggering voice frame aggregation as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network entity in accordance with examples as disclosed herein. For example, the communications manager 820 may be configured as or otherwise support a means for transmitting an indication of one or more parameters associated with a first frame aggregation configuration based at least in part on receiving a frame aggregation request message or a session setup message, where the one or more parameters includes at least a first parameter indicating a first quantity of frames per data packet. The communications manager 820 may be configured as or otherwise support a means for receiving one or more data packets in accordance with the first frame aggregation configuration upon successful activation of frame aggregation, where each of the one or more data packets includes a plurality of frames based at least in part on the first parameter.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for triggering voice frame aggregation which may result in reduced processing, reduced power consumption, more efficient utilization of communication resources, among other advantages.

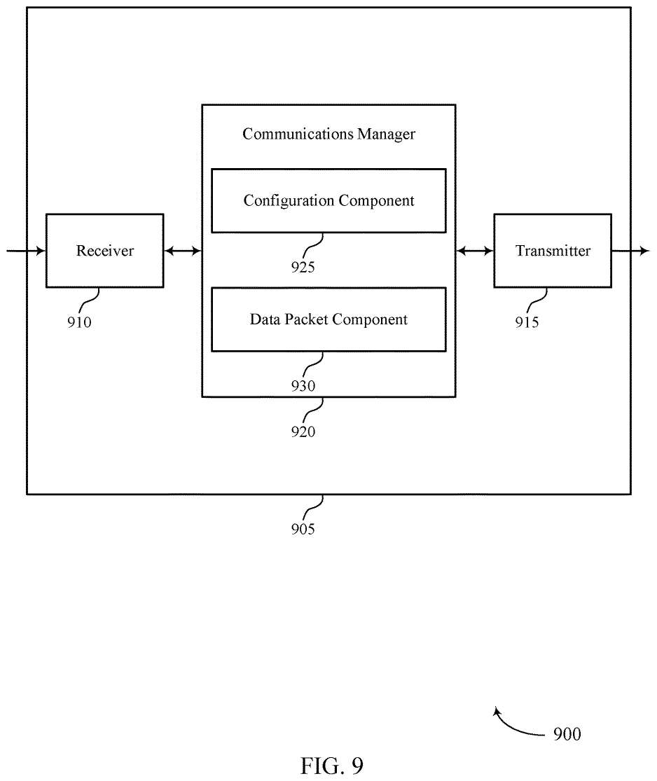

FIG. 9 shows a block diagram 900 of a device 905 that supports triggering voice frame aggregation in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of triggering voice frame aggregation as described herein. For example, the communications manager 920 may include a configuration component 925 a data packet component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. The configuration component 925 may be configured as or otherwise support a means for transmitting an indication of one or more parameters associated with a first frame aggregation configuration based at least in part on receiving a frame aggregation request message or a session setup message, where the one or more parameters includes at least a first parameter indicating a first quantity of frames per data packet. The data packet component 930 may be configured as or otherwise support a means for receiving one or more data packets in accordance with the first frame aggregation configuration upon successful activation of frame aggregation, where each of the one or more data packets includes a plurality of frames based at least in part on the first parameter.

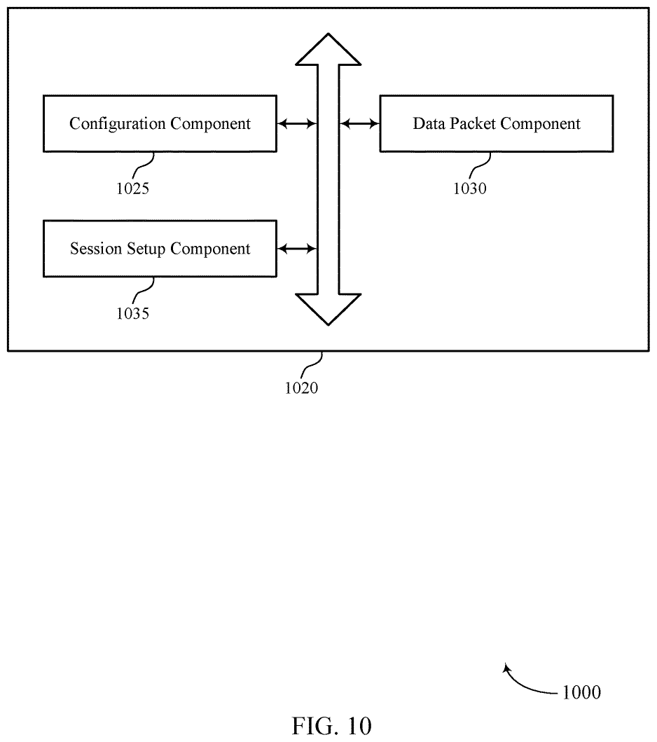

FIG. 10 shows a block diagram 1000 of a communications manager 1020 that supports triggering voice frame aggregation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of triggering voice frame aggregation as described herein. For example, the communications manager 1020 may include a configuration component 1025, a data packet component 1030, a session setup component 1035, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network entity in accordance with examples as disclosed herein. The configuration component 1025 may be configured as or otherwise support a means for transmitting an indication of one or more parameters associated with a first frame aggregation configuration based at least in part on receiving a frame aggregation request message or a session setup message, where the one or more parameters includes at least a first parameter indicating a first quantity of frames per data packet. The data packet component 1030 may be configured as or otherwise support a means for receiving one or more data packets in accordance with the first frame aggregation configuration upon successful activation of frame aggregation, where each of the one or more data packets includes a plurality of frames based at least in part on the first parameter.

In some examples, the session setup component 1035 may be configured as or otherwise support a means for receiving the session setup message, where transmitting the indication of the one or more parameters associated with the first frame aggregation configuration is based at least in part on receiving the session setup message. In some examples, the session setup component 1035 may be configured as or otherwise support a means for initiating a session setup procedure with a UE based at least in part on transmitting the indication of the one or more parameters associated with the first frame aggregation configuration. In some examples, the configuration component 1025 may be configured as or otherwise support a means for receiving an indication of one or more timing parameters associated with a session, where the one or more timing parameters are based at least in part on the first frame aggregation configuration.

In some examples, the session setup component 1035 may be configured as or otherwise support a means for initiating a session setup procedure with a UE. In some examples, the configuration component 1025 may be configured as or otherwise support a means for receiving the frame aggregation request message, where receiving the indication of the one or more parameters associated with the first frame aggregation configuration is based at least in part on the frame aggregation request message.

In some examples, to support transmitting the indication of the one or more parameters associated with the first frame aggregation configuration, the configuration component 1025 may be configured as or otherwise support a means for transmitting an indication of one or more QoS parameters associated with a communication link between a UE and the network entity, where the one or more parameters associated with the first frame aggregation configuration is based at least in part on the one or more QoS parameters.

In some examples, the one or more QoS parameters include the first parameter indicating the first quantity of frames per data packet.

In some examples, to support transmitting the indication of the one or more parameters associated with the first frame aggregation configuration, the configuration component 1025 may be configured as or otherwise support a means for transmitting an indication of a second parameter from the one or more QoS parameters, where the first quantity of frames per data packet is based at least in part on the second parameter from the one or more QoS parameters.

In some examples, to support receiving the one or more data packets, the configuration component 1025 may be configured as or otherwise support a means for receiving the one or more data packets in accordance with the first parameter based at least in part on a protocol associated with the first radio network, one or more characteristics associated with the first radio network, or both.

In some examples, the configuration component 1025 may be configured as or otherwise support a means for receiving a report indicating one or more parameters associated with a frame aggregation configuration used in a last connection between a UE and a second network entity, where the one or more parameters associated with the first frame aggregation configuration are based at least in part on the one or more parameters associated with the frame aggregation configuration used in the last connection.

In some examples, the configuration component 1025 may be configured as or otherwise support a means for transmitting a second indication of one or more parameters associated with a second frame aggregation configuration, where the one or more parameters associated with the second frame aggregation configuration includes at least a second parameter indication a second quantity of frames per data packet, and where the second quantity of frames is different than the first quantity of frames.

In some examples, the data packet component 1030 may be configured as or otherwise support a means for refraining from monitoring for a first data packet of the one or more data packets based at least in part on the second indication, where the first data packet includes the first quantity of frames.

In some examples, the data packet component 1030 may be configured as or otherwise support a means for receiving an indication of a quantity of data packets based at least in part on receiving the second indication, where the quantity of data packets is based at least in part on a quantity of data packets from the one or more data packets each including the first quantity of data frames.

In some examples, the configuration component 1025 may be configured as or otherwise support a means for transmitting an indication of one or more recommended timing parameters associated with a communication session between a UE and the network entity, where the one or more recommended timing parameters are based at least in part on the one or more parameters associated with the first frame aggregation configuration.

In some examples, the configuration component 1025 may be configured as or otherwise support a means for receiving a confirmation message indicating activation of the first frame aggregation configuration.

In some examples, to support receiving the one or more data packets, the data packet component 1030 may be configured as or otherwise support a means for receiving the one or more data packets via a communication channel of a plurality of communication channels, where the communication channel is based at least in part on the first frame aggregation configuration.

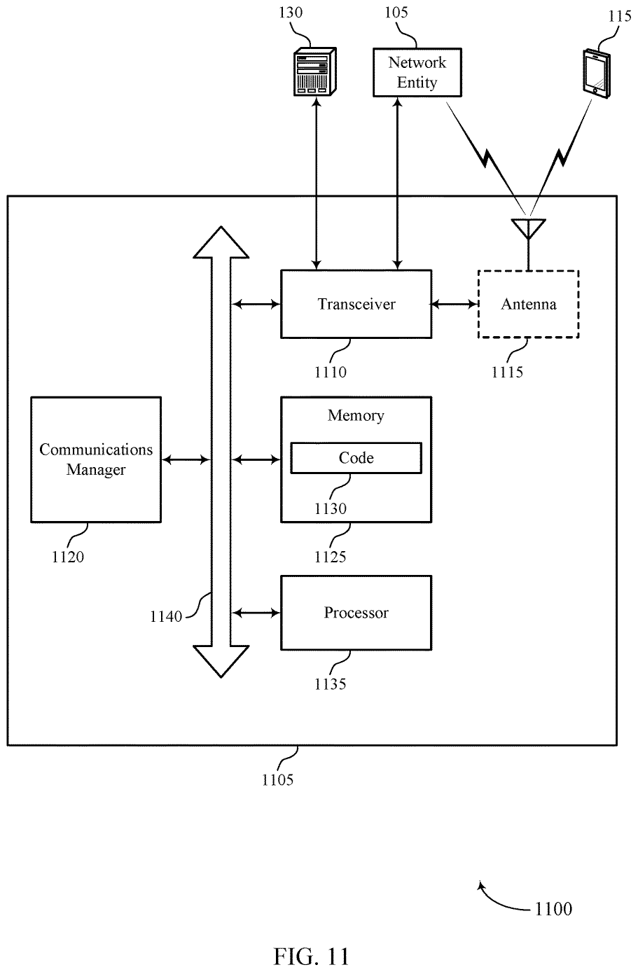

FIG. 11 shows a diagram of a system 1100 including a device 1105 that supports triggering voice frame aggregation in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based at least in part on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting triggering voice frame aggregation). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network entity in accordance with examples as disclosed herein. For example, the communications manager 1120 may be configured as or otherwise support a means for transmitting an indication of one or more parameters associated with a first frame aggregation configuration based at least in part on receiving a frame aggregation request message or a session setup message, where the one or more parameters includes at least a first parameter indicating a first quantity of frames per data packet. The communications manager 1120 may be configured as or otherwise support a means for receiving one or more data packets in accordance with the first frame aggregation configuration upon successful activation of frame aggregation, where each of the one or more data packets includes a plurality of frames based at least in part on the first parameter.

By including or configuring the communications manager 1120 in accordance with examples as described herein, the device 1105 may support techniques for triggering voice frame aggregation which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of triggering voice frame aggregation as described herein, or the processor 1135 and the memory 1125 may be otherwise configured to perform or support such operations.

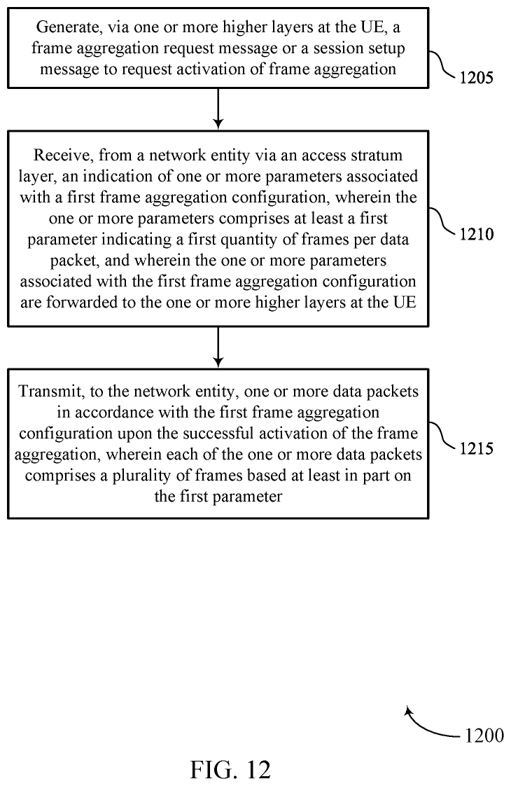

FIG. 12 shows a flowchart illustrating a method 1200 that supports triggering voice frame aggregation in accordance with one or more aspects of the present disclosure. The operations of the method 1200 may be implemented by a UE or its components as described herein. For example, the operations of the method 1200 may be performed by a UE 115 as described herein with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include generating, via one or more higher layers at the UE, a frame aggregation request message or a session setup message to request activation of frame aggregation. The operations of 1205 may be performed in accordance with examples as disclosed herein. In some examples, aspects of the operations of 1205 may be performed by a frame aggregation component 625 as described herein with reference to FIG. 6.

At 1210, the method may include receiving, from a network entity via an access stratum layer, an indication of one or more parameters associated with a first frame aggregation configuration, where the one or more parameters includes at least a first parameter indicating a first quantity of frames per data packet, and where the one or more parameters associated with the first frame aggregation configuration are forwarded to the one or more higher layers at the UE. The operations of 1215 may be performed in accordance with examples as disclosed herein. In some examples, aspects of the operations of 1215 may be performed by a parameter component 630 as described herein with reference to FIG. 6.

At 1215, the method may include transmitting, to the network entity, one or more data packets in accordance with the first frame aggregation configuration upon successful activation of the frame aggregation, where each of the one or more data packets includes a plurality of frames based at least in part on the first parameter. The operations of 1210 may be performed in accordance with examples as disclosed herein. In some examples, aspects of the operations of 1210 may be performed by a frame aggregation component 625 as described herein with reference to FIG. 6.

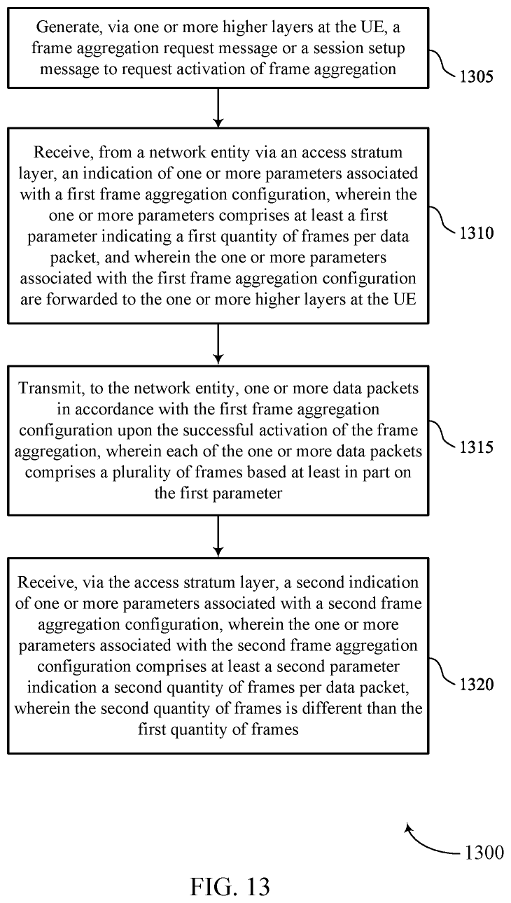

FIG. 13 shows a flowchart illustrating a method 1300 that supports triggering voice frame aggregation in accordance with one or more aspects of the present disclosure. The operations of the method 1300 may be implemented by a UE or its components as described herein. For example, the operations of the method 1300 may be performed by a UE 115 as described herein with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include generating, via one or more higher layers at the UE, a frame aggregation request message or a session setup message to request activation of frame aggregation. The operations of 1305 may be performed in accordance with examples as disclosed herein. In some examples, aspects of the operations of 1305 may be performed by a frame aggregation component 625 as described herein with reference to FIG. 6.

At 1310, the method include receiving, from a network entity via an access stratum layer, an indication of one or more parameters associated with a first frame aggregation configuration, where the one or more parameters includes at least a first parameter indicating a first quantity of frames per data packet, and where the one or more parameters associated with the first frame aggregation configuration are forwarded to the one or more higher layers at the UE. The operations of 1315 may be performed in accordance with examples as disclosed herein. In some examples, aspects of the operations of 1315 may be performed by a parameter component 630 as described herein with reference to FIG. 6.

At 1315, the method may include transmitting, to the network entity, one or more data packets in accordance with the first frame aggregation configuration upon successful activation of the frame aggregation, where each of the one or more data packets includes a plurality of frames based at least in part on the first parameter. The operations of 1310 may be performed in accordance with examples as disclosed herein. In some examples, aspects of the operations of 1310 may be performed by a frame aggregation component 625 as described herein with reference to FIG. 6.

At 1320, the method may include receiving, via the access stratum layer, a second indication of one or more parameters associated with a second frame aggregation configuration, where the one or more parameters associated with the second frame aggregation configuration includes at least a second parameter indication a second quantity of frames per data packet, where the second quantity of frames is different than the first quantity of frames. The operations of 1320 may be performed in accordance with examples as disclosed herein. In some examples, aspects of the operations of 1320 may be performed by a parameter component 630 as described herein with reference to FIG. 6.

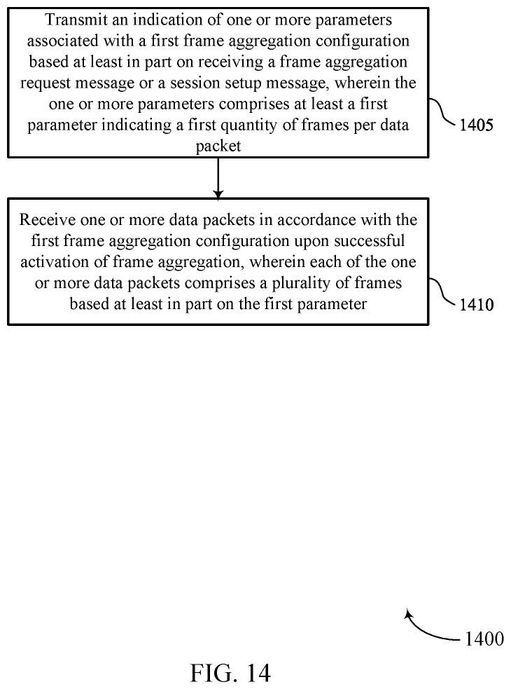

FIG. 14 shows a flowchart illustrating a method 1400 that supports triggering voice frame aggregation in accordance with one or more aspects of the present disclosure. The operations of the method 1400 may be implemented by a network entity or its components as described herein. For example, the operations of the method 1400 may be performed by a network entity as described herein with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include transmitting an indication of one or more parameters associated with a first frame aggregation configuration based at least in part on receiving a frame aggregation request message or a session setup message, where the one or more parameters includes at least a first parameter indicating a first quantity of frames per data packet. The operations of 1410 may be performed in accordance with examples as disclosed herein. In some examples, aspects of the operations of 1410 may be performed by a configuration component 1025 as described herein with reference to FIG. 10.

At 1410, the method may include receiving one or more data packets in accordance with the first frame aggregation configuration upon successful activation of frame aggregation, where each of the one or more data packets includes a plurality of frames based at least in part on the first parameter. The operations of 1405 may be performed in accordance with examples as disclosed herein. In some examples, aspects of the operations of 1405 may be performed by a data packet component 1030 as described herein with reference to FIG. 10.

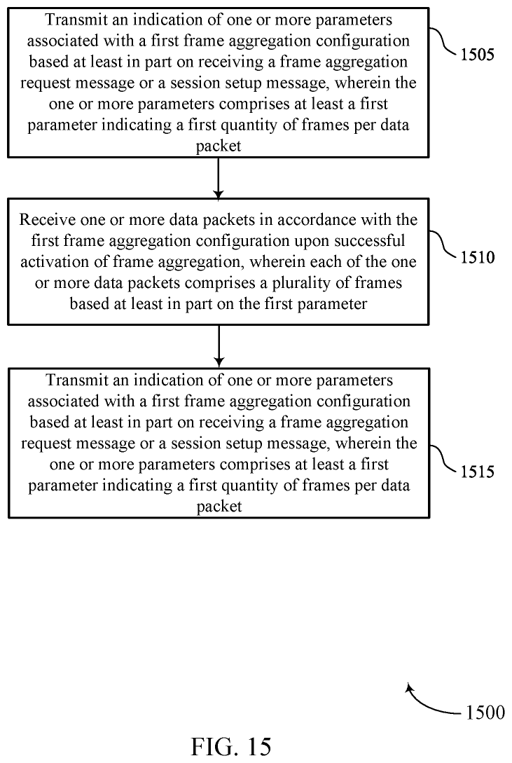

FIG. 15 shows a flowchart illustrating a method 1500 that supports triggering voice frame aggregation in accordance with one or more aspects of the present disclosure. The operations of the method 1500 may be implemented by a network entity or its components as described herein. For example, the operations of the method 1500 may be performed by a network entity as described herein with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include receiving one or more data packets in accordance with the first frame aggregation configuration upon successful activation of frame aggregation, where each of the one or more data packets includes a plurality of frames based at least in part on the first parameter. The operations of 1505 may be performed in accordance with examples as disclosed herein. In some examples, aspects of the operations of 1505 may be performed by a data packet component 1030 as described herein with reference to FIG. 10.

At 1510, the method may include transmitting an indication of one or more parameters associated with a first frame aggregation configuration based at least in part on receiving a frame aggregation request message or a session setup message, where the one or more parameters includes at least a first parameter indicating a first quantity of frames per data packet. The operations of 1515 may be performed in accordance with examples as disclosed herein. In some examples, aspects of the operations of 1515 may be performed by a configuration component 1025 as described herein with reference to FIG. 10.

At 1515, the method may include transmitting a second indication of one or more parameters associated with a second frame aggregation configuration, where the one or more parameters associated with the second frame aggregation configuration includes at least a second parameter indication a second quantity of frames per data packet, and where the second quantity of frames is different than the first quantity of frames. The operations of 1510 may be performed in accordance with examples as disclosed herein. In some examples, aspects of the operations of 1510 may be performed by a configuration component 1025 as described herein with reference to FIG. 10.

The following provides an overview of aspects of the present disclosure:

Aspect 1: A method for wireless communications at a UE, comprising: generating, via one or more higher layers at the UE, a frame aggregation request message or a session setup message to request activation of frame aggregation; receiving, from a network entity via an AS layer, an indication of one or more parameters associated with a first frame aggregation configuration, wherein the one or more parameters comprises at least a first parameter indicating a first quantity of frames per data packet, and wherein the one or more parameters associated with the first frame aggregation configuration are forwarded to the one or more higher layers at the UE; and transmitting, to the network entity, one or more data packets in accordance with the first frame aggregation configuration upon successful activation of frame aggregation, wherein each of the one or more data packets comprises a plurality of frames based at least in part on the first parameter.

Aspect 2: The method of aspect 1, further comprising: transmitting the session setup message, wherein receiving the indication of the one or more parameters associated with the first frame aggregation configuration is based at least in part on transmitting the session setup message; initiating a session setup procedure with the network entity based at least in part on receiving the indication of the one or more parameters associated with the first frame aggregation configuration; and transmitting an indication of one or more timing parameters associated with a session, wherein the one or more timing parameters are based at least in part on the first frame aggregation configuration.

Aspect 3: The method of aspect 1, further comprising: initiating a session setup procedure with the network entity; and transmitting the frame aggregation request message, wherein receiving the indication of the one or more parameters associated with the first frame aggregation configuration is based at least in part on the frame aggregation request message.

Aspect 4: The method of any of aspects 1 through 3, wherein receiving the indication of the one or more parameters associated with the first frame aggregation configuration comprises: receiving an indication of one or more quality of service parameters associated with a communication link between the UE and the network entity, wherein the one or more parameters associated with the first frame aggregation configuration is based at least in part on the one or more quality of services parameters.

Aspect 5: The method of aspect 4, wherein the one or more quality of service parameters comprise the first parameter indicating the first quantity of frames per data packet.

Aspect 6: The method of aspect 4, wherein receiving the indication of one or more quality of service parameters comprises: receiving an indication of a second parameter from the one or more quality of service parameters; and determining the first parameter indicating the first quantity of frames per data packet based at least in part on the second parameter from the one or more quality of service parameters.

Aspect 7: The method of any of aspects 1 through 6, wherein the first parameter from the one or more parameters is associated with a first radio network and a second parameter from the one or more parameters is associated with a second radio network, and wherein transmitting the one or more data packets comprises: transmitting the one or more data packets in accordance with the first parameter based at least in part on a protocol associated with the first radio network, one or more characteristics associated with the first radio network, or both.

Aspect 8: The method of any of aspects 1 through 7, further comprising: transmitting a report indicating one or more parameters associated with a frame aggregation configuration used in a last connection between the UE and a second network entity, wherein the one or more parameters associated with the first frame aggregation configuration are based at least in part on the one or more parameters associated with the frame aggregation configuration used in a last connection.

Aspect 9: The method of any of aspects 1 through 8, further comprising: receiving, via the AS layer, a second indication of one or more parameters associated with a second frame aggregation configuration, wherein the one or more parameters associated with the second frame aggregation configuration comprises at least a second parameter indication a second quantity of frames per data packet, wherein the second quantity of frames is different than the first quantity of frames.

Aspect 10: The method of aspect 9, further comprising: refraining from transmitting a first data packet of the one or more data packets based at least in part on the second indication, wherein the first data packet comprises the first quantity of frames.

Aspect 11: The method of aspect 9, further comprising: reconstructing a first data packet of the one or more data packets into a second data packet of the one or more data packets, wherein the first data packet comprises the first quantity of frames and the second data packet comprises the second quantity of frames.

Aspect 12: The method of aspect 9, further comprising: transmitting an indication of a quantity of data packets based at least in part on receiving the second indication, wherein the quantity of data packets is based at least in part on a quantity of data packets from the one or more data packets each comprising the first quantity of data frames.

Aspect 13: The method of any of aspects 1 through 12, further comprising: receiving an indication of one or more recommended timing parameters associated with a communication session between the UE and the network entity, wherein the one or more recommended timing parameters are based at least in part on the one or more parameters associated with the first frame aggregation configuration.

Aspect 14: The method of any of aspects 1 through 13, further comprising: transmitting a confirmation message indicating the successful activation of the frame aggregation.

Aspect 15: The method of any of aspects 1 through 14, wherein transmitting the one or more data packets comprises: transmitting the one or more data packets via a communication channel of a plurality of communication channels, wherein the communication channel is based at least in part on the first frame aggregation configuration.

Aspect 16: A method for wireless communications at a network entity, comprising: transmitting an indication of one or more parameters associated with a first frame aggregation configuration based at least in part on receiving a frame aggregation request message or a session setup message, wherein the one or more parameters comprises at least a first parameter indicating a first quantity of frames per data packet; and receiving one or more data packets in accordance with the first frame aggregation configuration upon successful activation of frame aggregation, wherein each of the one or more data packets comprises a plurality of frames based at least in part on the first parameter.

Aspect 17: The method of aspect 16, further comprising: receiving the session setup message, wherein transmitting the indication of the one or more parameters associated with the first frame aggregation configuration is based at least in part on receiving the session setup message; initiating a session setup procedure with a UE based at least in part on transmitting the indication of the one or more parameters associated with the first frame aggregation configuration; and receiving an indication of one or more timing parameters associated with a session, wherein the one or more timing parameters are based at least in part on the first frame aggregation configuration.

Aspect 18: The method of aspect 16, further comprising: initiating a session setup procedure with a UE; and receiving the frame aggregation request message, wherein receiving the indication of the one or more parameters associated with the first frame aggregation configuration is based at least in part on the frame aggregation request message.

Aspect 19: The method of any of aspects 16 through 18, wherein transmitting the indication of the one or more parameters associated with the first frame aggregation configuration comprises: transmitting an indication of one or more quality of service parameters associated with a communication link between a UE and the network entity, wherein the one or more parameters associated with the first frame aggregation configuration is based at least in part on the one or more quality of services parameters.

Aspect 20: The method of aspect 19, wherein the one or more quality of service parameters comprise the first parameter indicating the first quantity of frames per data packet.

Aspect 21: The method of aspect 19, wherein transmitting the indication of the one or more parameters associated with the first frame aggregation configuration comprises: transmitting an indication of a second parameter from the one or more quality of service parameters, wherein the first quantity of frames per data packet is based at least in part on the second parameter from the one or more quality of service parameters.

Aspect 22: The method of any of aspects 16 through 21, wherein the first parameter from the one or more parameters is associated with a first radio network and a second parameter from the one or more parameters is associated with a second radio network, and wherein receiving the one or more data packets comprises: receiving the one or more data packets in accordance with the first parameter based at least in part on a protocol associated with the first radio network, one or more characteristics associated with the first radio network, or both.

Aspect 23: The method of any of aspects 16 through 22, further comprising: receiving a report indicating one or more parameters associated with a frame aggregation configuration used in a last connection between a UE and a second network entity, wherein the one or more parameters associated with the first frame aggregation configuration are based at least in part on the one or more parameters associated with the frame aggregation configuration used in a last connection.

Aspect 24: The method of any of aspects 16 through 23, further comprising: transmitting a second indication of one or more parameters associated with a second frame aggregation configuration, wherein the one or more parameters associated with the second frame aggregation configuration comprises at least a second parameter indication a second quantity of frames per data packet, and wherein the second quantity of frames is different than the first quantity of frames.

Aspect 25: The method of aspect 24, further comprising: refraining from monitoring for a first data packet of the one or more data packets based at least in part on the second indication, wherein the first data packet comprises the first quantity of frames.

Aspect 26: The method of aspect 24, further comprising: receiving an indication of a quantity of data packets based at least in part on receiving the second indication, wherein the quantity of data packets is based at least in part on a quantity of data packets from the one or more data packets each comprising the first quantity of data frames.

Aspect 27: The method of any of aspects 16 through 26, further comprising: transmitting an indication of one or more recommended timing parameters associated with a communication session between a UE and the network entity, wherein the one or more recommended timing parameters are based at least in part on the one or more parameters associated with the first frame aggregation configuration.

Aspect 28: The method of any of aspects 16 through 27, further comprising: receiving a confirmation message indicating enablement of the first frame aggregation configuration.

Aspect 29: The method of any of aspects 16 through 28, wherein receiving the one or more data packets comprises: receiving the one or more data packets via a communication channel of a plurality of communication channels, wherein the communication channel is based at least in part on the first frame aggregation configuration.

Aspect 30: An apparatus for wireless communications at a UE, comprising a processor; memory coupled with the processor; and instructions stored in the memory and executable by the processor to cause the apparatus to perform a method of any of aspects 1 through 15.

Aspect 31: An apparatus for wireless communications at a UE, comprising at least one means for performing a method of any of aspects 1 through 15.

Aspect 32: A non-transitory computer-readable medium storing code for wireless communications at a UE, the code comprising instructions executable by a processor to perform a method of any of aspects 1 through 15.

Aspect 33: An apparatus for wireless communications at a network entity, comprising a processor; memory coupled with the processor; and instructions stored in the memory and executable by the processor to cause the apparatus to perform a method of any of aspects 16 through 29.

Aspect 34: An apparatus for wireless communications at a network entity, comprising at least one means for performing a method of any of aspects 16 through 29.

Aspect 35: A non-transitory computer-readable medium storing code for wireless communications at a network entity, the code comprising instructions executable by a processor to perform a method of any of aspects 16 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
at least one memory coupled with the at least one processor, with instructions stored in the at least one memory, the instructions being executable by the at least one processor, individually or in any combination, to cause the apparatus to:
receive, from a network entity via an access stratum layer, an indication of one or more parameters associated with a first frame aggregation configuration, wherein the one or more parameters comprises at least a first parameter indicating a first quantity of frames per data packet, and wherein the one or more parameters associated with the first frame aggregation configuration are forwarded to one or more higher layers at the UE; and
transmit, to the network entity, one or more data packets in accordance with the first frame aggregation configuration upon successful activation of frame aggregation, wherein each of the one or more data packets comprises a plurality of frames based at least in part on the first parameter.

2. The apparatus of claim 1, wherein the instructions are further executable by the at least one processor to cause the apparatus to:
initiate a session setup procedure with the network entity based at least in part on receiving an indication of the one or more parameters associated with the first frame aggregation configuration; and
transmit an indication of one or more timing parameters associated with a session, wherein the one or more timing parameters are based at least in part on the first frame aggregation configuration.

3. The apparatus of claim 1, wherein the instructions are further executable by the at least one processor to cause the apparatus to:
initiate a session setup procedure with the network entity; and
transmit a frame aggregation request message, wherein receiving the indication of the one or more parameters associated with the first frame aggregation configuration is based at least in part on the frame aggregation request message.

4. The apparatus of claim 1, wherein the instructions to receive the indication of the one or more parameters associated with the first frame aggregation configuration are executable by the at least one processor to cause the apparatus to:
receive an indication of one or more quality of service parameters associated with a communication link between the UE and the network entity, wherein the one or more parameters associated with the first frame aggregation configuration is based at least in part on the one or more quality of services parameters.

5. The apparatus of claim 4, wherein the one or more quality of service parameters comprise the first parameter indicating the first quantity of frames per data packet.

6. The apparatus of claim 4, wherein the instructions to receive the indication of one or more quality of service parameters are executable by the at least one processor to cause the apparatus to:
receive an indication of a second parameter from the one or more quality of service parameters; and
determine the first parameter indicating the first quantity of frames per data packet based at least in part on the second parameter from the one or more quality of service parameters.

7. The apparatus of claim 1, wherein the first parameter from the one or more parameters is associated with a first radio network and a second parameter from the one or more parameters is associated with a second radio network, and wherein the instructions to transmit the one or more data packets are executable by the at least one processor to cause the apparatus to:
transmit the one or more data packets in accordance with the first parameter based at least in part on a protocol associated with the first radio network, one or more characteristics associated with the first radio network, or both.

8. The apparatus of claim 1, wherein the instructions are further executable by the at least one processor to cause the apparatus to:
transmit a report indicating one or more parameters associated with a frame aggregation configuration used in a last connection between the UE and a second network entity, wherein the one or more parameters associated with the first frame aggregation configuration are based at least in part on the one or more parameters associated with the frame aggregation configuration used in the last connection.

9. The apparatus of claim 1, wherein the instructions are further executable by the at least one processor to cause the apparatus to:
receive, via the access stratum layer, a second indication of one or more parameters associated with a second frame aggregation configuration, wherein the one or more parameters associated with the second frame aggregation configuration comprises at least a second parameter indication a second quantity of frames per data packet, wherein the second quantity of frames is different than the first quantity of frames.

10. The apparatus of claim 9, wherein the instructions are further executable by the at least one processor to cause the apparatus to:
refrain from transmitting a first data packet of the one or more data packets based at least in part on the second indication, wherein the first data packet comprises the first quantity of frames.

11. The apparatus of claim 9, wherein the instructions are further executable by the at least one processor to cause the apparatus to:
reconstruct a first data packet of the one or more data packets into a second data packet of the one or more data packets, wherein the first data packet comprises the first quantity of frames and the second data packet comprises the second quantity of frames.

12. The apparatus of claim 9, wherein the instructions are further executable by the at least one processor to cause the apparatus to:
transmit an indication of a quantity of data packets based at least in part on receiving the second indication, wherein the quantity of data packets is based at least in part on a quantity of data packets from the one or more data packets each comprising the first quantity of data frames.

13. The apparatus of claim 1, wherein the instructions are further executable by the at least one processor to cause the apparatus to:
receive an indication of one or more recommended timing parameters associated with a communication session between the UE and the network entity, wherein the one or more recommended timing parameters are based at least in part on the one or more parameters associated with the first frame aggregation configuration.

14. The apparatus of claim 1, wherein the instructions are further executable by the at least one processor to cause the apparatus to:
transmit a confirmation message indicating the successful activation of the frame aggregation via a radio resource control (RRC) message or medium access control (MAC)-control element (MAC-CE) message.

15. The apparatus of claim 14, wherein the confirmation message comprises the one or more parameters associated with the first frame aggregation configuration, the one or more parameters being different than one or more second parameters associated with a frame aggregation request.

16. The apparatus of claim 1, wherein the instructions to transmit the one or more data packets are executable by the at least one processor to cause the apparatus to:
transmit the one or more data packets via a communication channel of a plurality of communication channels, wherein the communication channel is based at least in part on the first frame aggregation configuration.

17. An apparatus for wireless communications at a network entity, comprising:
at least one processor; and
at least one memory coupled with the at least one processor, with instructions stored in the at least one memory, the instructions being executable by the at least one processor, individually or collectively, to cause the apparatus to:
transmit an indication of one or more parameters associated with a first frame aggregation configuration, wherein the one or more parameters comprises at least a first parameter indicating a first quantity of frames per data packet;
receive a confirmation message indicating successful activation of frame aggregation at a user equipment (UE); and
receive one or more data packets in accordance with the first frame aggregation configuration based on the successful activation of frame aggregation, wherein each of the one or more data packets comprises a plurality of frames based at least in part on the first parameter.

18. The apparatus of claim 17, wherein the confirmation message is received from the UE via a radio resource control (RRC) message or medium access control (MAC)-control element (MAC-CE) message.

19. The apparatus of claim 18, wherein the confirmation message comprises the one or more parameters associated with the first frame aggregation configuration, the one or more parameters being different than one or more second parameters associated with a frame aggregation request.

20. The apparatus of claim 17, wherein the confirmation message is received from a second network entity.

21. The apparatus of claim 17, wherein the instructions to transmit the indication of the one or more parameters associated with the first frame aggregation configuration are executable by the at least one processor to cause the apparatus to:
transmit an indication of one or more quality of service parameters associated with a communication link between a UE and the network entity, wherein the one or more parameters associated with the first frame aggregation configuration is based at least in part on the one or more quality of services parameters.

22. The apparatus of claim 21, wherein the one or more quality of service parameters comprise the first parameter indicating the first quantity of frames per data packet.

23. The apparatus of claim 21, wherein the instructions to transmit the indication of the one or more parameters associated with the first frame aggregation configuration are executable by the at least one processor to cause the apparatus to:
transmit an indication of a second parameter from the one or more quality of service parameters, wherein the first quantity of frames per data packet is based at least in part on the second parameter from the one or more quality of service parameters.

24. The apparatus of claim 17, wherein the first parameter from the one or more parameters is associated with a first radio network and a second parameter from the one or more parameters is associated with a second radio network, and wherein the instructions to receive the one or more data packets are executable by the at least one processor to cause the apparatus to:
receive the one or more data packets in accordance with the first parameter based at least in part on a protocol associated with the first radio network, one or more characteristics associated with the first radio network, or both.

25. The apparatus of claim 17, wherein the instructions are further executable by the at least one processor to cause the apparatus to:
receive a report indicating one or more parameters associated with a frame aggregation configuration used in a last connection between a UE and a second network entity, wherein the one or more parameters associated with the first frame aggregation configuration are based at least in part on the one or more parameters associated with the frame aggregation configuration used in the last connection.

26. The apparatus of claim 17, wherein the instructions are further executable by the at least one processor to cause the apparatus to:
transmit a second indication of one or more parameters associated with a second frame aggregation configuration, wherein the one or more parameters associated with the second frame aggregation configuration comprises at least a second parameter indication a second quantity of frames per data packet, and wherein the second quantity of frames is different than the first quantity of frames.

27. The apparatus of claim 26, wherein the instructions are further executable by the at least one processor to cause the apparatus to:
refrain from monitoring for a first data packet of the one or more data packets based at least in part on the second indication, wherein the first data packet comprises the first quantity of frames.

28. The apparatus of claim 26, wherein the instructions are further executable by the at least one processor to cause the apparatus to:
receive an indication of a quantity of data packets based at least in part on receiving the second indication, wherein the quantity of data packets is based at least in part on a quantity of data packets from the one or more data packets each comprising the first quantity of data frames.

29. A method for wireless communications at a user equipment (UE), comprising:
receiving, from a network entity via an access stratum layer, an indication of one or more parameters associated with a first frame aggregation configuration, wherein the one or more parameters comprises at least a first parameter indicating a first quantity of frames per data packet, and wherein the one or more parameters associated with the first frame aggregation configuration are forwarded to one or more higher layers at the UE; and
transmitting, to the network entity, one or more data packets in accordance with the first frame aggregation configuration upon successful activation of frame aggregation, wherein each of the one or more data packets comprises a plurality of frames based at least in part on the first parameter.

30. A method for wireless communications at a network entity, comprising:
transmitting an indication of one or more parameters associated with a first frame aggregation configuration, wherein the one or more parameters comprises at least a first parameter indicating a first quantity of frames per data packet;
receiving a confirmation message indicating successful activation of frame aggregation at a user equipment (UE); and
receiving one or more data packets in accordance with the first frame aggregation configuration based on the successful activation of frame aggregation, wherein each of the one or more data packets comprises a plurality of frames based at least in part on the first parameter.
